(19) United States
(12) Patent Application Publication
(10) Pub. No.: US 2019/0338972 A1
(43) Pub. Date: Nov. 7, 2019

(54) BUILDING MANAGEMENT SYSTEM AND METHODS FOR PREDICTING CATASTROPHIC HVAC EQUIPMENT FAILURES

(71) Applicant: Johnson Controls Technology Company, Auburn Hills, MI (US)

(72) Inventors: Kelsey C. Schuster, Wauwatosa, WI (US); Steven R. Vitullo, Milwaukee, WI (US)

(73) Assignee: Johnson Controls Technology Company, Auburn Hills, MI (US)

(21) Appl. No.: 15/968,187

(22) Filed: May 1, 2018

(51) Int. Cl. F24F 11/38; G05B 13/02

(52) U.S. Cl. CPC F24F 11/38; F24F 2140/12; G05B 13/026

(57) ABSTRACT

A Building Management System (BMS) is configured to monitor and control building equipment. The BMS includes a number of sensors configured to transmit input data associated with the building equipment. The BMS further includes a condition based maintenance scheduler configured to determine a number of potential problems associated with the building equipment based on the input data. The condition based maintenance scheduler determines the number of potential problems by comparing the input data to a set of conditions. The BMS is further configured to schedule a number of maintenance events associated with the building equipment based on the number of potential problems.

### BACKGROUND

The present disclosure relates generally to a building control system and more particularly to a Building Management System (BMS). A BMS is, in general, a system of devices configured to control, monitor, and manage equipment in or around a building or building area. A BMS can include, for example, an HVAC system, a security system, a lighting system, a fire alerting system, any other system that is capable of managing building functions or devices, or any combination thereof.

### SUMMARY

One implementation of the present disclosure is a Building Management System (BMS) configured to monitor and control building equipment. The BMS includes a number of sensors configured to transmit input data associated with the building equipment. The BMS also includes a condition based maintenance scheduler configured to determine a number of potential problems associated with the building equipment based on the input data. The condition based maintenance scheduler determines the number of potential problems by comparing the input data to a set of conditions. The BMS is further configured to schedule a number of maintenance events associated with the building equipment based on the number of potential problems.

In some embodiments, the building equipment includes a chiller assembly configured to remove heat from a liquid by performing a vapor-compression cycle or an absorption refrigeration cycle.

In some embodiments, the number of potential problems includes at least one of the following: low pressure within an evaporator of the chiller assembly, high pressure within a condenser of the chiller assembly, high temperature of oil near a compressor of the chiller assembly, current overload of an electric motor of the chiller assembly, and high temperature of one or more heat sinks associated with one or more inverters of a variable speed drive of the chiller assembly.

In some embodiments, the condition based maintenance scheduler is configured to determine the potential problem of low pressure within the evaporator of the chiller assembly by comparing the input data to the set of conditions, and wherein the set of conditions includes at least one of a temperature difference threshold between a drop leg temperature and a chilled water supply temperature, an evaporator temperature change threshold, an evaporator approach temperature threshold, and an evaporator pressure threshold.

In some embodiments, at least one of the following is true: the temperature difference threshold is zero degrees Fahrenheit, the evaporator temperature change threshold is between 12 and 17 degrees Fahrenheit, the evaporator approach temperature threshold is twice that of a designed evaporator approach temperature, and the evaporator pressure threshold varies depending on a type of the liquid.

In some embodiments, wherein the condition based maintenance scheduler is configured to determine the potential problem of high pressure within the condenser of the chiller assembly by comparing the input data to the set of conditions, and wherein the set of conditions includes a condenser temperature change threshold, a condenser approach temperature threshold, and a condenser pressure threshold.

In some embodiments, at least one of the following is true: the condenser temperature change threshold is between 12 and 17 degrees Fahrenheit, the condenser approach temperature threshold is twice that of a designed condenser approach temperature, and the condenser pressure threshold varies depending on a type of the liquid.

In some embodiments, the condition based maintenance scheduler is configured to determine the potential problem of high temperature of oil near the compressor of the chiller assembly by comparing the input data to the set of conditions, and wherein the set of conditions includes an oil sump temperature threshold, an oil sump pressure threshold, and an oil pump pressure threshold.

In some embodiments, at least one of the following is true: the oil sump temperature threshold is between 120 and 170 degrees Fahrenheit, the oil sump pressure threshold is between 40 and 50 pounds per square inch, and the oil pump pressure threshold is between 75 and 85 pounds per square inch.

In some embodiments, the condition based maintenance scheduler is configured to determine the potential problem of current overload of an electric motor of the chiller assembly by comparing the input data to the set of conditions, and wherein the set of conditions includes an evaporator temperature change threshold, a condenser temperature change threshold, and a full-load-amperage threshold associated with the electric motor.

In some embodiments, at least one of the following is true: the evaporator temperature change threshold is between 12 and 17 degrees Fahrenheit, the condenser temperature change threshold is between 12 and 17 degrees Fahrenheit, and the full-load-amperage threshold is 100 percent.

In some embodiments, the condition based maintenance scheduler is configured to determine the potential problem of high temperature of one or more heat sinks associated with one or more inverters of a variable speed drive of the chiller assembly by comparing the input data to the set of conditions, and wherein the set of conditions includes a condenser temperature change threshold and an ambient air temperature threshold associated with the variable speed drive.

In some embodiments, at least one of the following is true: the condenser temperature change threshold is between 12 and 17 degrees Fahrenheit and the ambient air temperature threshold is between 110 and 130 degrees Fahrenheit.

In some embodiments, the BMS is further configured to present the input data and the number of potential problems to one or more users via a dashboard interface.

In some embodiments, the liquid is a R22 type refrigerant or a R134A type refrigerant.

Another implementation of the present disclosure is a method performed by a Building Management System (BMS) configured to monitor and control building equipment. The method includes receiving input data associated with the building equipment from a number of sensors. The method further includes determining a number of potential problems associated with the building equipment by comparing the input data to a set of conditions. The method further includes scheduling a number of maintenance events associated with the building equipment based on the number of potential problems.

In some embodiments, the building equipment includes a chiller assembly configured to remove heat from a liquid by performing a vapor-compression cycle or an absorption refrigeration cycle.

In some embodiments, the number of potential problems includes at least one of the following: low pressure within an evaporator of the chiller assembly, high pressure within a condenser of the chiller assembly, high temperature of oil near a compressor of the chiller assembly, current overload of an electric motor of the chiller assembly, and high temperature of one or more heat sinks associated with one or more inverters of a variable speed drive of the chiller assembly.

In some embodiments, the set of conditions includes at least one of an evaporator temperature change threshold, a temperature difference threshold between a drop leg temperature and a chilled water supply temperature, an evaporator approach temperature threshold, an evaporator pressure threshold, a condenser temperature change threshold, a condenser approach temperature threshold, a condenser pressure threshold, an oil sump temperature threshold, an oil sump pressure threshold, an oil pump pressure threshold, a full-load-amperage threshold associated with an electric motor, and an ambient air temperature threshold associated with a variable speed drive.

Another implementation of the present disclosure is a method. The method includes providing a Building Management System (BMS) configured to monitor and control building equipment. The BMS includes a number of sensors configured to transmit input data associated with the building equipment. The BMS further includes a condition based maintenance scheduler configured to determine a number of potential problems associated with the building equipment based on the input data. The condition based maintenance scheduler determines the number of potential problems by comparing the input data to a set of conditions. The BMS is further configured to schedule a number of maintenance events associated with the building equipment based on the number of potential problems.

Those skilled in the art will appreciate this summary is illustrative only and is not intended to be in any way limiting. Other aspects, inventive features, and advantages of the devices and/or processes described herein, as defined solely by the claims, will become apparent in the detailed description set forth herein and taken in conjunction with the accompanying drawings.

### BRIEF DESCRIPTION OF THE DRAWINGS

FIG. 1 is a drawing of a building equipped with a HVAC system, according to an exemplary embodiment.

FIG. 2 is a schematic of a waterside system which can be used as part of the HVAC system of FIG. 1, according to some embodiments.

FIG. 3 is a block diagram of an airside system which can be used as part of the HVAC system of FIG. 1, according to some embodiments.

FIG. 4 is a block diagram of a BMS which can be used in the building of FIG. 1, according to some embodiments.

FIG. 5 is drawing of a chiller assembly which can be used as part of the HVAC system of FIG. 1, according to some embodiments.

FIG. 6 is a block diagram of a condition based maintenance system that can be integrated with the BMS of FIG. 4, according to some embodiments.

FIG. 7 is a block diagram of a condition based maintenance scheduler associated with the condition based maintenance system of FIG. 6, according to some embodiments.

FIG. 8 is a table depicting an example of input parameters associated with the condition based maintenance system of FIG. 6, according to some embodiments.

FIG. 9 is a table depicting an example of an output associated with the condition based maintenance system of FIG. 6, according to some embodiments.

FIG. 10 is a graph depicting an example of input data associated with the condition based maintenance system of FIG. 6, according to some embodiments.

FIG. 11 is another graph depicting an example of input data associated with the condition based maintenance system of FIG. 6, according to some embodiments.

FIG. 12 is another graph depicting an example of input data associated with the condition based maintenance system of FIG. 6, according to some embodiments.

FIG. 13 is another graph depicting an example of input data associated with the condition based maintenance system of FIG. 6, according to some embodiments.

FIG. 14 is another graph depicting an example of input data associated with the condition based maintenance system of FIG. 6, according to some embodiments.

### DETAILED DESCRIPTION

Referring generally to the FIGURES, a building management system (BMS) with condition based maintenance is shown, according to some embodiments. The BMS may include a condition based maintenance scheduler configured to predictively diagnose problems with building equipment. The condition based maintenance scheduler can diagnose potential problems by comparing input data received from building equipment to a set of conditions. The set of conditions can be customized and can include rules and other logic used by the condition based maintenance scheduler to flag potential problems with building equipment. As opposed to maintenance that is scheduled based on a time interval, the condition based maintenance scheduler can be configured to schedule maintenance based on operating conditions of building equipment. This feature allows for a more efficient and effective BMS.

Building with HVAC System

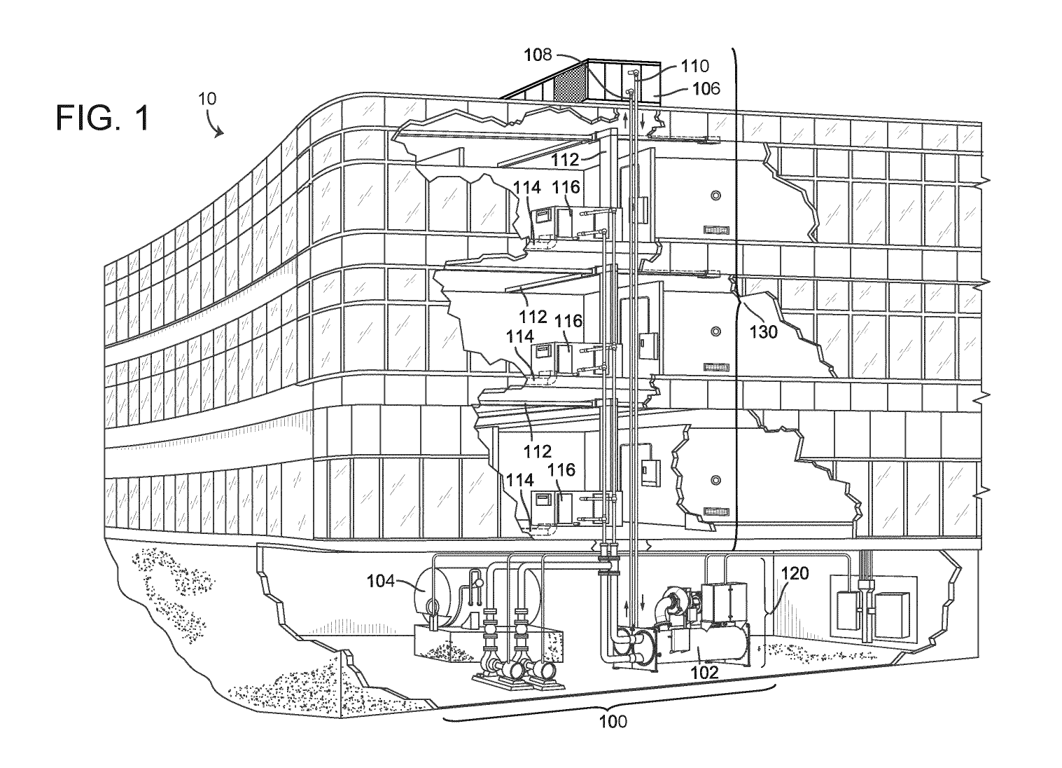

Referring now to FIG. 1, a perspective view of a building 10 is shown. Building 10 is served by a building management system (BAS). A BMS is, in general, a system of devices configured to control, monitor, and manage equipment in or around a building or building area. A BMS can include, for example, a HVAC system, a security system, a lighting system, a fire alerting system, any other system that is capable of managing building functions or devices, or any combination thereof.

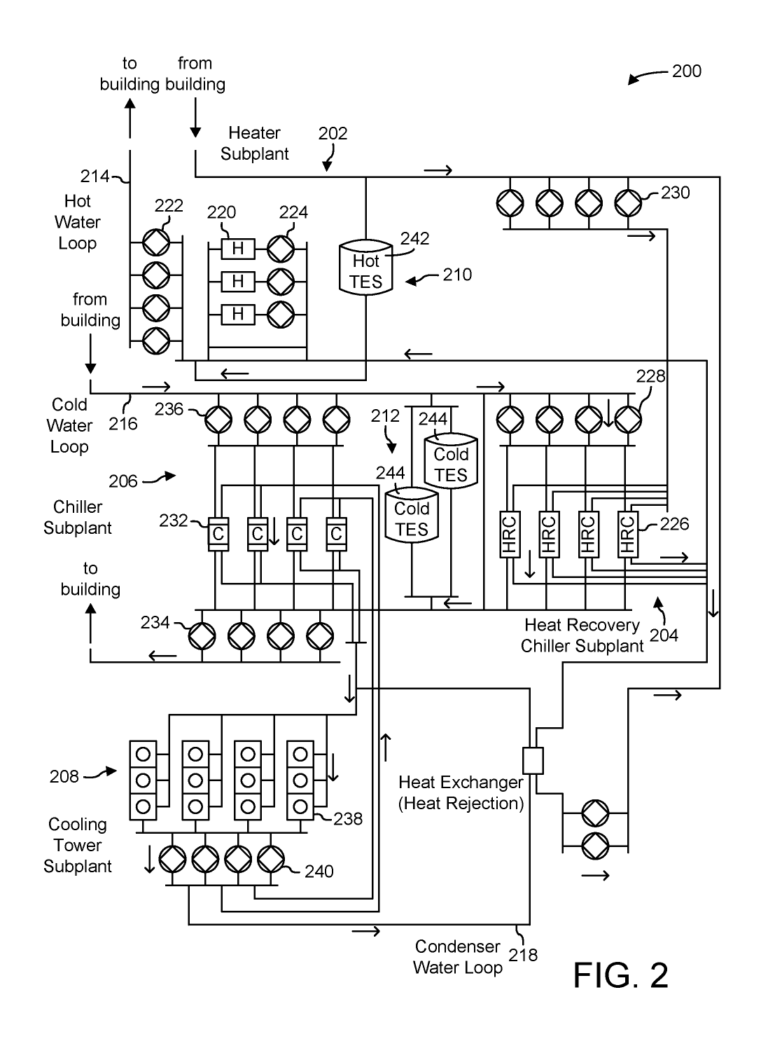

The BMS that serves building 10 includes an HVAC system 100. HVAC system 100 may include a plurality of HVAC devices (e.g., heaters, chillers, air handling units, pumps, fans, thermal energy storage, etc.) configured to provide heating, cooling, ventilation, or other services for building 10. For example, HVAC system 100 is shown to include a waterside system 120 and an airside system 130. Waterside system 120 may provide a heated or chilled fluid to an air handling unit of airside system 130. Airside system 130 may use the heated or chilled fluid to heat or cool an airflow provided to building 10. In some embodiments, waterside system 120 is replaced with a central energy plant such as central plant 200, described with reference to FIG. 2.

Still referring to FIG. 1, HVAC system 100 is shown to include a chiller 102, a boiler 104, and a rooftop air handling unit (AHU) 106. Waterside system 120 may use boiler 104 and chiller 102 to heat or cool a working fluid (e.g., water, glycol, etc.) and may circulate the working fluid to AHU 106. In various embodiments, the HVAC devices of waterside system 120 may be located in or around building 10 (as shown in FIG. 1) or at an offsite location such as a central plant (e.g., a chiller plant, a steam plant, a heat plant, etc.). The working fluid may be heated in boiler 104 or cooled in chiller 102, depending on whether heating or cooling is required in building 10. Boiler 104 may add heat to the circulated fluid, for example, by burning a combustible material (e.g., natural gas) or using an electric heating element. Chiller 102 may place the circulated fluid in a heat exchange relationship with another fluid (e.g., a refrigerant) in a heat exchanger (e.g., an evaporator) to absorb heat from the circulated fluid. The working fluid from chiller 102 and/or boiler 104 may be transported to AHU 106 via piping 108.

AHU 106 may place the working fluid in a heat exchange relationship with an airflow passing through AHU 106 (e.g., via one or more stages of cooling coils and/or heating coils). The airflow may be, for example, outside air, return air from within building 10, or a combination of both. AHU 106 may transfer heat between the airflow and the working fluid to provide heating or cooling for the airflow. For example, AHU 106 may include one or more fans or blowers configured to pass the airflow over or through a heat exchanger containing the working fluid. The working fluid may then return to chiller 102 or boiler 104 via piping 110.

Airside system 130 may deliver the airflow supplied by AHU 106 (i.e., the supply airflow) to building 10 via air supply ducts 112 and may provide return air from building 10 to AHU 106 via air return ducts 114. In some embodiments, airside system 130 includes multiple variable air volume (VAV) units 116. For example, airside system 130 is shown to include a separate VAV unit 116 on each floor or zone of building 10. VAV units 116 may include dampers or other flow control elements that can be operated to control an amount of the supply airflow provided to individual zones of building 10. In other embodiments, airside system 130 delivers the supply airflow into one or more zones of building 10 (e.g., via air supply ducts 112) without using intermediate VAV units 116 or other flow control elements. AHU 106 may include various sensors (e.g., temperature sensors, pressure sensors, etc.) configured to measure attributes of the supply airflow. AHU 106 may receive input from sensors located within AHU 106 and/or within the building zone and may adjust the flow rate, temperature, or other attributes of the supply airflow through AHU 106 to achieve setpoint conditions for the building zone.

### Central Plant and Control System

Referring now to FIG. 2, a block diagram of a central plant 200 is shown, according to an exemplary embodiment. In brief overview, central plant 200 may include various types of equipment configured to serve the thermal energy loads of a building or campus (i.e., a system of buildings). For example, central plant 200 may include heaters, chillers, heat recovery chillers, cooling towers, or other types of equipment configured to serve the heating and/or cooling loads of a building or campus. Central plant 200 may consume resources from a utility (e.g., electricity, water, natural gas, etc.) to heat or cool a working fluid that is circulated to one or more buildings or stored for later use (e.g., in thermal energy storage tanks) to provide heating or cooling for the buildings. In various embodiments, central plant 200 may supplement or replace waterside system 120 in building 10 or may be implemented separate from building 10 (e.g., at an offsite location).

Central plant 200 is shown to include a plurality of subplants 202-212 including a heater subplant 202, a heat recovery chiller subplant 204, a chiller subplant 206, a cooling tower subplant 208, a hot thermal energy storage (TES) subplant 210, and a cold thermal energy storage (TES) subplant 212. Subplants 202-212 consume resources from utilities to serve the thermal energy loads (e.g., hot water, cold water, heating, cooling, etc.) of a building or campus. For example, heater subplant 202 may be configured to heat water in a hot water loop 214 that circulates the hot water between heater subplant 202 and building 10. Chiller subplant 206 may be configured to chill water in a cold water loop 216 that circulates the cold water between chiller subplant 206 building 10. Heat recovery chiller subplant 204 may be configured to transfer heat from cold water loop 216 to hot water loop 214 to provide additional heating for the hot water and additional cooling for the cold water. Condenser water loop 218 may absorb heat from the cold water in chiller subplant 206 and reject the absorbed heat in cooling tower subplant 208 or transfer the absorbed heat to hot water loop 214. Hot TES subplant 210 and cold TES subplant 212 may store hot and cold thermal energy, respectively, for subsequent use.

Hot water loop 214 and cold water loop 216 may deliver the heated and/or chilled water to air handlers located on the rooftop of building 10 (e.g., AHU 106) or to individual floors or zones of building 10 (e.g., VAV units 116). The air handlers push air past heat exchangers (e.g., heating coils or cooling coils) through which the water flows to provide heating or cooling for the air. The heated or cooled air may be delivered to individual zones of building 10 to serve the thermal energy loads of building 10. The water then returns to subplants 202-212 to receive further heating or cooling.

Although subplants 202-212 are shown and described as heating and cooling water for circulation to a building, it is understood that any other type of working fluid (e.g., glycol, CO₂, etc.) may be used in place of or in addition to water to serve the thermal energy loads. In other embodiments, subplants 202-212 may provide heating and/or cooling directly to the building or campus without requiring an intermediate heat transfer fluid. These and other variations to central plant 200 are within the teachings of the present invention.

Each of subplants 202-212 may include a variety of equipment configured to facilitate the functions of the subplant. For example, heater subplant 202 is shown to include a plurality of heating elements 220 (e.g., boilers, electric heaters, etc.) configured to add heat to the hot water in hot water loop 214. Heater subplant 202 is also shown to include several pumps 222 and 224 configured to circulate the hot water in hot water loop 214 and to control the flow rate of the hot water through individual heating elements 220. Chiller subplant 206 is shown to include a plurality of chillers 232 configured to remove heat from the cold water in cold water loop 216. Chiller subplant 206 is also shown to include several pumps 234 and 236 configured to circulate the cold water in cold water loop 216 and to control the flow rate of the cold water through individual chillers 232.

Heat recovery chiller subplant 204 is shown to include a plurality of heat recovery heat exchangers 226 (e.g., refrigeration circuits) configured to transfer heat from cold water loop 216 to hot water loop 214. Heat recovery chiller subplant 204 is also shown to include several pumps 228 and 230 configured to circulate the hot water and/or cold water through heat recovery heat exchangers 226 and to control the flow rate of the water through individual heat recovery heat exchangers 226. Cooling tower subplant 208 is shown to include a plurality of cooling towers 238 configured to remove heat from the condenser water in condenser water loop 218. Cooling tower subplant 208 is also shown to include several pumps 240 configured to circulate the condenser water in condenser water loop 218 and to control the flow rate of the condenser water through individual cooling towers 238.

Hot TES subplant 210 is shown to include a hot TES tank 242 configured to store the hot water for later use. Hot TES subplant 210 may also include one or more pumps or valves configured to control the flow rate of the hot water into or out of hot TES tank 242. Cold TES subplant 212 is shown to include cold TES tanks 244 configured to store the cold water for later use. Cold TES subplant 212 may also include one or more pumps or valves configured to control the flow rate of the cold water into or out of cold TES tanks 244.

In some embodiments, one or more of the pumps in central plant 200 (e.g., pumps 222, 224, 228, 230, 234, 236, and/or 240) or pipelines in central plant 200 include an isolation valve associated therewith. Isolation valves may be integrated with the pumps or positioned upstream or downstream of the pumps to control the fluid flows in central plant 200. In various embodiments, central plant 200 may include more, fewer, or different types of devices and/or subplants based on the particular configuration of central plant 200 and the types of loads served by central plant 200.

### Airside System

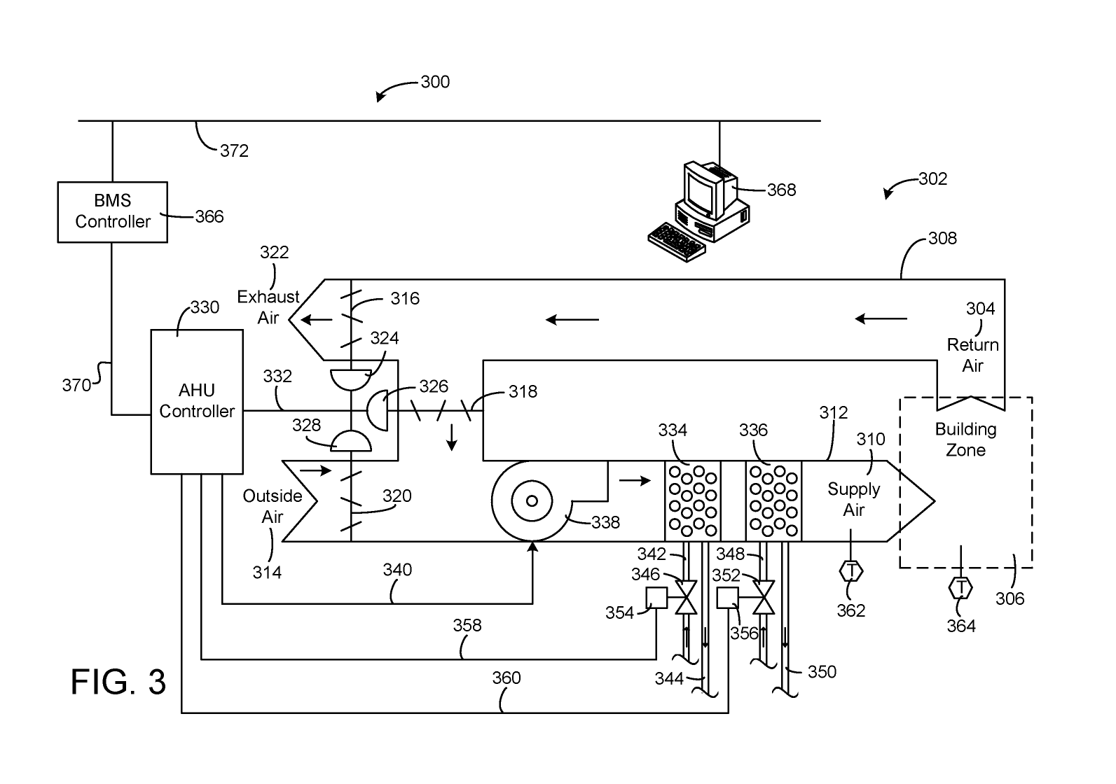

Referring now to FIG. 3, a block diagram of an airside system 300 is shown, according to an example embodiment. In various embodiments, airside system 300 can supplement or replace airside system 130 in HVAC system 100 or can be implemented separate from HVAC system 100. When implemented in HVAC system 100, airside system 300 can include a subset of the HVAC devices in HVAC system 100 (e.g., AHU 106, VAV units 116, duct 112, duct 114, fans, dampers, etc.) and can be located in or around building 10. Airside system 300 can operate to heat or cool an airflow provided to building 10 using a heated or chilled fluid provided by waterside system 200.

In FIG. 3, airside system 300 is shown to include an economizer-type air handling unit (AHU) 302. Economizer-type AHUs vary the amount of outside air and return air used by the air handling unit for heating or cooling. For example, AHU 302 can receive return air 304 from building zone 306 via return air duct 308 and can deliver supply air 310 to building zone 306 via supply air duct 312. In some embodiments, AHU 302 is a rooftop unit located on the roof of building 10 (e.g., AHU 106 as shown in FIG. 1) or otherwise positioned to receive both return air 304 and outside air 314. AHU 302 can be configured to operate exhaust air damper 316, mixing damper 318, and outside air damper 320 to control an amount of outside air 314 and return air 304 that combine to form supply air 310. Any return air 304 that does not pass through mixing damper 318 can be exhausted from AHU 302 through exhaust damper 316 as exhaust air 322.

Each of dampers 316-320 can be operated by an actuator. For example, exhaust air damper 316 can be operated by actuator 324, mixing damper 318 can be operated by actuator 326, and outside air damper 320 can be operated by actuator 328. Actuators 324-328 can communicate with an AHU controller 330 via a communications link 332. Actuators 324-328 can receive control signals from AHU controller 330 and can provide feedback signals to AHU controller 330. Feedback signals can include, for example, an indication of a current actuator or damper position, an amount of torque or force exerted by the actuator, diagnostic information (e.g., results of diagnostic tests performed by actuators 324-328), status information, commissioning information, configuration settings, calibration data, and/or other types of information or data that can be collected, stored, or used by actuators 324-328. AHU controller 330 can be an economizer controller configured to use one or more control algorithms (e.g., state-based algorithms, extremum seeking control (ESC) algorithms, proportional-integral (PI) control algorithms, proportional-integral-derivative (PID) control algorithms, model predictive control (MPC) algorithms, feedback control algorithms, etc.) to control actuators 324-328.

Still referring to FIG. 3, AHU 302 is shown to include a cooling coil 334, a heating coil 336, and a fan 338 positioned within supply air duct 312. Fan 338 can be configured to force supply air 310 through cooling coil 334 and/or heating coil 336 and provide supply air 310 to building zone 306. AHU controller 330 can communicate with fan 338 via communications link 340 to control a flow rate of supply air 310. In some embodiments, AHU controller 330 controls an amount of heating or cooling applied to supply air 310 by modulating a speed of fan 338.

Cooling coil 334 can receive a chilled fluid from waterside system 200 (e.g., from cold water loop 216) via piping 342 and can return the chilled fluid to waterside system 200 via piping 344. Valve 346 can be positioned along piping 342 or piping 344 to control a flow rate of the chilled fluid through cooling coil 334. In some embodiments, cooling coil 334 includes multiple stages of cooling coils that can be independently activated and deactivated (e.g., by AHU controller 330, by BMS controller 366, etc.) to modulate an amount of cooling applied to supply air 310.

Heating coil 336 can receive a heated fluid from waterside system 200 (e.g., from hot water loop 214) via piping 348 and can return the heated fluid to waterside system 200 via piping 350. Valve 352 can be positioned along piping 348 or piping 350 to control a flow rate of the heated fluid through heating coil 336. In some embodiments, heating coil 336 includes multiple stages of heating coils that can be independently activated and deactivated (e.g., by AHU controller 330, by BMS controller 366, etc.) to modulate an amount of heating applied to supply air 310.

Each of valves 346 and 352 can be controlled by an actuator. For example, valve 346 can be controlled by actuator 354 and valve 352 can be controlled by actuator 356. Actuators 354-356 can communicate with AHU controller 330 via communications links 358-360. Actuators 354-356 can receive control signals from AHU controller 330 and can provide feedback signals to controller 330. In some embodiments, AHU controller 330 receives a measurement of the supply air temperature from a temperature sensor 362 positioned in supply air duct 312 (e.g., downstream of cooling coil 334 and/or heating coil 336). AHU controller 330 can also receive a measurement of the temperature of building zone 306 from a temperature sensor 364 located in building zone 306.

In some embodiments, AHU controller 330 operates valves 346 and 352 via actuators 354-356 to modulate an amount of heating or cooling provided to supply air 310 (e.g., to achieve a setpoint temperature for supply air 310 or to maintain the temperature of supply air 310 within a setpoint temperature range). The positions of valves 346 and 352 affect the amount of heating or cooling provided to supply air 310 by cooling coil 334 or heating coil 336 and may correlate with the amount of energy consumed to achieve a desired supply air temperature. AHU controller 330 can control the temperature of supply air 310 and/or building zone 306 by activating or deactivating coils 334-336, adjusting a speed of fan 338, or a combination of both.

Still referring to FIG. 3, airside system 300 is shown to include a building management system (BMS) controller 366 and a client device 368. BMS controller 366 can include one or more computer systems (e.g., servers, supervisory controllers, subsystem controllers, etc.) that serve as system level controllers, application or data servers, head nodes, or master controllers for airside system 300, waterside system 200, HVAC system 100, and/or other controllable systems that serve building 10. BMS controller 366 can communicate with multiple downstream building systems or subsystems (e.g., HVAC system 100, a security system, a lighting system, waterside system 200, etc.) via a communications link 370 according to like or disparate protocols (e.g., LON, BACnet, etc.). In various embodiments, AHU controller 330 and BMS controller 366 can be separate (as shown in FIG. 3) or integrated. In an integrated implementation, AHU controller 330 can be a software module configured for execution by a processor of BMS controller 366.

In some embodiments, AHU controller 330 receives information from BMS controller 366 (e.g., commands, setpoints, operating boundaries, etc.) and provides information to BMS controller 366 (e.g., temperature measurements, valve or actuator positions, operating statuses, diagnostics, etc.). For example, AHU controller 330 can provide BMS controller 366 with temperature measurements from temperature sensors 362 and 364, equipment on/off states, equipment operating capacities, and/or any other information that can be used by BMS controller 366 to monitor or control a variable state or condition within building zone 306.

Client device 368 can include one or more human-machine interfaces or client interfaces (e.g., graphical user interfaces, reporting interfaces, text-based computer interfaces, client-facing web services, web servers that provide pages to web clients, etc.) for controlling, viewing, or otherwise interacting with HVAC system 100, its subsystems, and/or devices. Client device 368 can be a computer workstation, a client terminal, a remote or local interface, or any other type of user interface device. Client device 368 can be a stationary terminal or a mobile device. For example, client device 368 can be a desktop computer, a computer server with a user interface, a laptop computer, a tablet, a smartphone, a PDA, or any other type of mobile or non-mobile device. Client device 368 can communicate with BMS controller 366 and/or AHU controller 330 via communications link 372.

### Building Management System

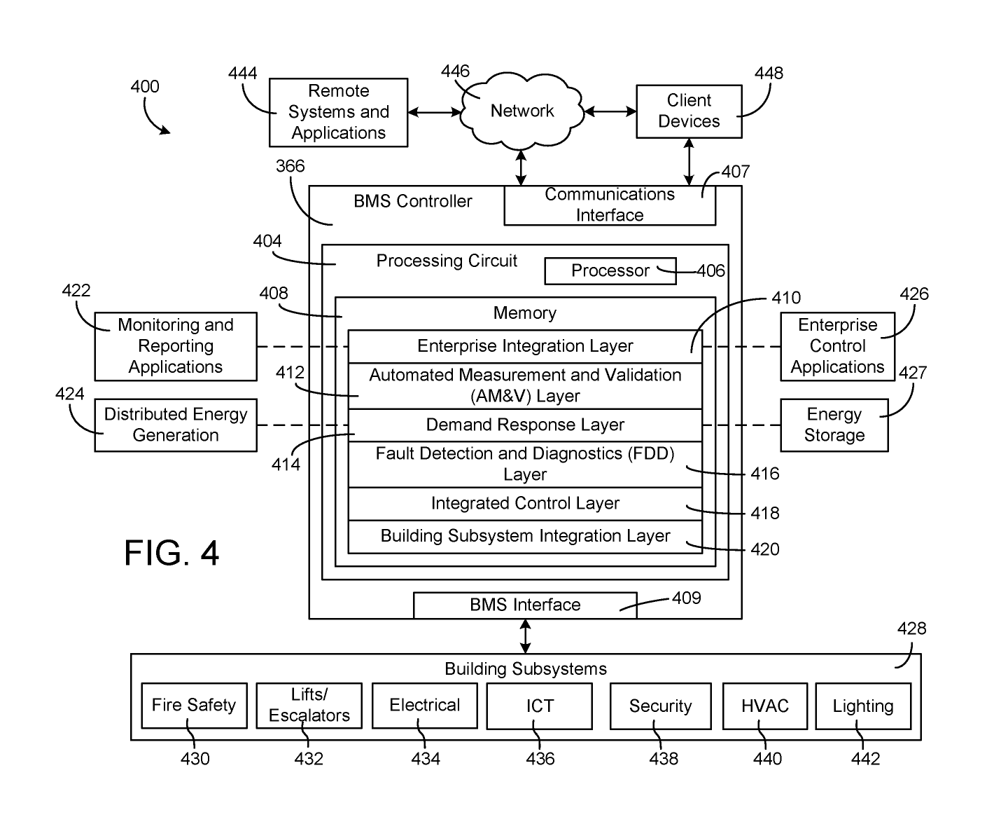

Referring now to FIG. 4, a block diagram of a building management system (BMS) 400 is shown, according to an example embodiment. BMS 400 can be implemented in building 10 to automatically monitor and control various building functions. BMS 400 is shown to include BMS controller 366 and a plurality of building subsystems 428. Building subsystems 428 are shown to include a building electrical subsystem 434, an information communication technology (ICT) subsystem 436, a security subsystem 438, a HVAC subsystem 440, a lighting subsystem 442, a lift/escalators subsystem 432, and a fire safety subsystem 430. In various embodiments, building subsystems 428 can include fewer, additional, or alternative subsystems. For example, building subsystems 428 can also or alternatively include a refrigeration subsystem, an advertising or signage subsystem, a cooking subsystem, a vending subsystem, a printer or copy service subsystem, or any other type of building subsystem that uses controllable equipment and/or sensors to monitor or control building 10. In some embodiments, building subsystems 428 include waterside system 200 and/or airside system 300, as described with reference to FIGS. 2 and 3.

Each of building subsystems 428 can include any number of devices, controllers, and connections for completing its individual functions and control activities. HVAC subsystem 440 can include many of the same components as HVAC system 100, as described with reference to FIGS. 1-3. For example, HVAC subsystem 440 can include a chiller, a boiler, any number of air handling units, economizers, field controllers, supervisory controllers, actuators, temperature sensors, and other devices for controlling the temperature, humidity, airflow, or other variable conditions within building 10. Lighting subsystem 442 can include any number of light fixtures, ballasts, lighting sensors, dimmers, or other devices configured to controllably adjust the amount of light provided to a building space. Security subsystem 438 can include occupancy sensors, video surveillance cameras, digital video recorders, video processing servers, intrusion detection devices, access control devices (e.g., card access, etc.) and servers, or other security-related devices.

Still referring to FIG. 4, BMS controller 366 is shown to include a communications interface 407 and a BMS interface 409. Interface 407 can facilitate communications between BMS controller 366 and external applications (e.g., monitoring and reporting applications 422, enterprise control applications 426, remote systems and applications 444, applications residing on client devices 448, etc.) for allowing user control, monitoring, and adjustment to BMS controller 366 and/or subsystems 428. Interface 407 can also facilitate communications between BMS controller 366 and client devices 448. BMS interface 409 can facilitate communications between BMS controller 366 and building subsystems 428 (e.g., HVAC, lighting security, lifts, power distribution, business, etc.).

Interfaces 407, 409 can be or include wired or wireless communications interfaces (e.g., jacks, antennas, transmitters, receivers, transceivers, wire terminals, etc.) for conducting data communications with building subsystems 428 or other external systems or devices. In various embodiments, communications via interfaces 407, 409 can be direct (e.g., local wired or wireless communications) or via a communications network 446 (e.g., a WAN, the Internet, a cellular network, etc.). For example, interfaces 407, 409 can include an Ethernet card and port for sending and receiving data via an Ethernet-based communications link or network. In another example, interfaces 407, 409 can include a Wi-Fi transceiver for communicating via a wireless communications network. In another example, one or both of interfaces 407, 409 can include cellular or mobile phone communications transceivers. In one embodiment, communications interface 407 is a power line communications interface and BMS interface 409 is an Ethernet interface. In other embodiments, both communications interface 407 and BMS interface 409 are Ethernet interfaces or are the same Ethernet interface.

Still referring to FIG. 4, BMS controller 366 is shown to include a processing circuit 404 including a processor 406 and memory 408. Processing circuit 404 can be communicably connected to BMS interface 409 and/or communications interface 407 such that processing circuit 404 and the various components thereof can send and receive data via interfaces 407, 409. Processor 406 can be implemented as a general purpose processor, an application specific integrated circuit (ASIC), one or more field programmable gate arrays (FPGAs), a group of processing components, or other suitable electronic processing components.

Memory 408 (e.g., memory, memory unit, storage device, etc.) can include one or more devices (e.g., RAM, ROM, Flash memory, hard disk storage, etc.) for storing data and/or computer code for completing or facilitating the various processes, layers and modules described in the present application. Memory 408 can be or include volatile memory or non-volatile memory. Memory 408 can include database components, object code components, script components, or any other type of information structure for supporting the various activities and information structures described in the present application. According to an example embodiment, memory 408 is communicably connected to processor 406 via processing circuit 404 and includes computer code for executing (e.g., by processing circuit 404 and/or processor 406) one or more processes described herein.

In some embodiments, BMS controller 366 is implemented within a single computer (e.g., one server, one housing, etc.). In various other embodiments BMS controller 366 can be distributed across multiple servers or computers (e.g., that can exist in distributed locations). Further, while FIG. 4 shows applications 422 and 426 as existing outside of BMS controller 366, in some embodiments, applications 422 and 426 can be hosted within BMS controller 366 (e.g., within memory 408).

Still referring to FIG. 4, memory 408 is shown to include an enterprise integration layer 410, an automated measurement and validation (AM&V) layer 412, a demand response (DR) layer 414, a fault detection and diagnostics (FDD) layer 416, an integrated control layer 418, and a building subsystem integration later 420. Layers 410-420 can be configured to receive inputs from building subsystems 428 and other data sources, determine optimal control actions for building subsystems 428 based on the inputs, generate control signals based on the optimal control actions, and provide the generated control signals to building subsystems 428. The following paragraphs describe some of the general functions performed by each of layers 410-420 in BMS 400.

Enterprise integration layer 410 can be configured to serve clients or local applications with information and services to support a variety of enterprise-level applications. For example, enterprise control applications 426 can be configured to provide subsystem-spanning control to a graphical user interface (GUI) or to any number of enterprise-level business applications (e.g., accounting systems, user identification systems, etc.). Enterprise control applications 426 can also or alternatively be configured to provide configuration GUIs for configuring BMS controller 366. In yet other embodiments, enterprise control applications 426 can work with layers 410-420 to optimize building performance (e.g., efficiency, energy use, comfort, or safety) based on inputs received at interface 407 and/or BMS interface 409.

Building subsystem integration layer 420 can be configured to manage communications between BMS controller 366 and building subsystems 428. For example, building subsystem integration layer 420 can receive sensor data and input signals from building subsystems 428 and provide output data and control signals to building subsystems 428. Building subsystem integration layer 420 can also be configured to manage communications between building subsystems 428. Building subsystem integration layer 420 translate communications (e.g., sensor data, input signals, output signals, etc.) across a plurality of multi-vendor/multi-protocol systems.

Demand response layer 414 can be configured to optimize resource usage (e.g., electricity use, natural gas use, water use, etc.) and/or the monetary cost of such resource usage in response to satisfy the demand of building 10. The optimization can be based on time-of-use prices, curtailment signals, energy availability, or other data received from utility providers, distributed energy generation systems 424, from energy storage 427 (e.g., hot TES 242, cold TES 244, etc.), or from other sources. Demand response layer 414 can receive inputs from other layers of BMS controller 366 (e.g., building subsystem integration layer 420, integrated control layer 418, etc.). The inputs received from other layers can include environmental or sensor inputs such as temperature, carbon dioxide levels, relative humidity levels, air quality sensor outputs, occupancy sensor outputs, room schedules, and the like. The inputs can also include inputs such as electrical use (e.g., expressed in kWh), thermal load measurements, pricing information, projected pricing, smoothed pricing, curtailment signals from utilities, and the like.

According to an example embodiment, demand response layer 414 includes control logic for responding to the data and signals it receives. These responses can include communicating with the control algorithms in integrated control layer 418, changing control strategies, changing setpoints, or activating/deactivating building equipment or subsystems in a controlled manner. Demand response layer 414 can also include control logic configured to determine when to utilize stored energy. For example, demand response layer 414 can determine to begin using energy from energy storage 427 just prior to the beginning of a peak use hour.

In some embodiments, demand response layer 414 includes a control module configured to actively initiate control actions (e.g., automatically changing setpoints) which minimize energy costs based on one or more inputs representative of or based on demand (e.g., price, a curtailment signal, a demand level, etc.). In some embodiments, demand response layer 414 uses equipment models to determine an optimal set of control actions. The equipment models can include, for example, thermodynamic models describing the inputs, outputs, and/or functions performed by various sets of building equipment. Equipment models can represent collections of building equipment (e.g., subplants, chiller arrays, etc.) or individual devices (e.g., individual chillers, heaters, pumps, etc.).

Demand response layer 414 can further include or draw upon one or more demand response policy definitions (e.g., databases, XML files, etc.). The policy definitions can be edited or adjusted by a user (e.g., via a graphical user interface) so that the control actions initiated in response to demand inputs can be tailored for the user's application, desired comfort level, particular building equipment, or based on other concerns. For example, the demand response policy definitions can specify which equipment can be turned on or off in response to particular demand inputs, how long a system or piece of equipment should be turned off, what setpoints can be changed, what the allowable set point adjustment range is, how long to hold a high demand setpoint before returning to a normally scheduled setpoint, how close to approach capacity limits, which equipment modes to utilize, the energy transfer rates (e.g., the maximum rate, an alarm rate, other rate boundary information, etc.) into and out of energy storage devices (e.g., thermal storage tanks, battery banks, etc.), and when to dispatch on-site generation of energy (e.g., via fuel cells, a motor generator set, etc.).

Integrated control layer 418 can be configured to use the data input or output of building subsystem integration layer 420 and/or demand response later 414 to make control decisions. Due to the subsystem integration provided by building subsystem integration layer 420, integrated control layer 418 can integrate control activities of the subsystems 428 such that the subsystems 428 behave as a single integrated supersystem. In an example embodiment, integrated control layer 418 includes control logic that uses inputs and outputs from a plurality of building subsystems to provide greater comfort and energy savings relative to the comfort and energy savings that separate subsystems could provide alone. For example, integrated control layer 418 can be configured to use an input from a first subsystem to make an energy-saving control decision for a second subsystem. Results of these decisions can be communicated back to building subsystem integration layer 420.

Integrated control layer 418 is shown to be logically below demand response layer 414. Integrated control layer 418 can be configured to enhance the effectiveness of demand response layer 414 by enabling building subsystems 428 and their respective control loops to be controlled in coordination with demand response layer 414. This configuration may advantageously reduce disruptive demand response behavior relative to conventional systems. For example, integrated control layer 418 can be configured to assure that a demand response-driven upward adjustment to the setpoint for chilled water temperature (or another component that directly or indirectly affects temperature) does not result in an increase in fan energy (or other energy used to cool a space) that would result in greater total building energy use than was saved at the chiller.

Integrated control layer 418 can be configured to provide feedback to demand response layer 414 so that demand response layer 414 checks that constraints (e.g., temperature, lighting levels, etc.) are properly maintained even while demanded load shedding is in progress. The constraints can also include setpoint or sensed boundaries relating to safety, equipment operating limits and performance, comfort, fire codes, electrical codes, energy codes, and the like. Integrated control layer 418 is also logically below fault detection and diagnostics layer 416 and automated measurement and validation layer 412. Integrated control layer 418 can be configured to provide calculated inputs (e.g., aggregations) to these higher levels based on outputs from more than one building subsystem.

Automated measurement and validation (AM&V) layer 412 can be configured to verify that control strategies commanded by integrated control layer 418 or demand response layer 414 are working properly (e.g., using data aggregated by AM&V layer 412, integrated control layer 418, building subsystem integration layer 420, FDD layer 416, or otherwise). The calculations made by AM&V layer 412 can be based on building system energy models and/or equipment models for individual BMS devices or subsystems. For example, AM&V layer 412 can compare a model-predicted output with an actual output from building subsystems 428 to determine an accuracy of the model.

Fault detection and diagnostics (FDD) layer 416 can be configured to provide on-going fault detection for building subsystems 428, building subsystem devices (i.e., building equipment), and control algorithms used by demand response layer 414 and integrated control layer 418. FDD layer 416 can receive data inputs from integrated control layer 418, directly from one or more building subsystems or devices, or from another data source. FDD layer 416 can automatically diagnose and respond to detected faults. The responses to detected or diagnosed faults can include providing an alert message to a user, a maintenance scheduling system, or a control algorithm configured to attempt to repair the fault or to work-around the fault.

FDD layer 416 can be configured to output a specific identification of the faulty component or cause of the fault (e.g., loose damper linkage) using detailed subsystem inputs available at building subsystem integration layer 420. In other example embodiments, FDD layer 416 is configured to provide “fault” events to integrated control layer 418 which executes control strategies and policies in response to the received fault events. According to an example embodiment, FDD layer 416 (or a policy executed by an integrated control engine or business rules engine) can shut-down systems or direct control activities around faulty devices or systems to reduce energy waste, extend equipment life, or assure proper control response.

FDD layer 416 can be configured to store or access a variety of different system data stores (or data points for live data). FDD layer 416 can use some content of the data stores to identify faults at the equipment level (e.g., specific chiller, specific AHU, specific terminal unit, etc.) and other content to identify faults at component or subsystem levels. For example, building subsystems 428 can generate temporal (i.e., time-series) data indicating the performance of BMS 400 and the various components thereof. The data generated by building subsystems 428 can include measured or calculated values that exhibit statistical characteristics and provide information about how the corresponding system or process (e.g., a temperature control process, a flow control process, etc.) is performing in terms of error from its setpoint. These processes can be examined by FDD layer 416 to expose when the system begins to degrade in performance and alert a user to repair the fault before it becomes more severe.

### Chiller Assembly

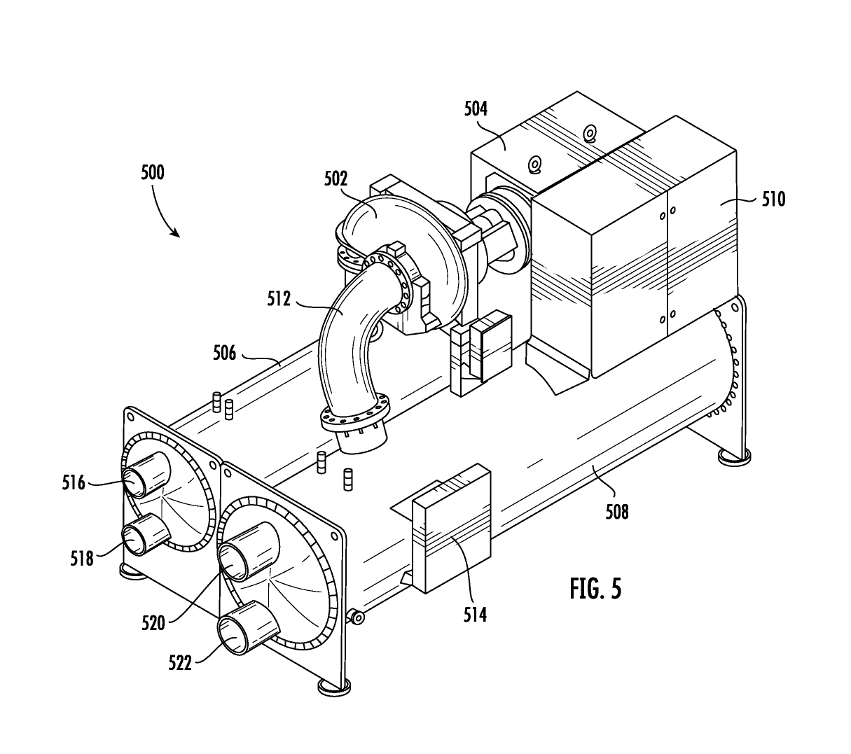

Referring specifically to FIG. 5, an example implementation of a chiller assembly 500 is shown, according to some embodiments. Chiller assembly 500 may be identical or nearly identical to chiller 102 described above. Chiller assembly 500 is shown to include a compressor 502 driven by a motor 504, a condenser 506, and an evaporator 508. A refrigerant can be circulated through chiller assembly 500 in a vapor compression cycle or an absorption refrigeration cycle. The refrigerant can be a low pressure refrigerant with an operating pressure less than 400 kPa, for example. Chiller assembly 500 can also include a control panel 514 configured to control operation of the vapor compression cycle within chiller assembly 500. Control panel 514 may be connected to a variety of sensors (e.g., pressure sensors, temperature sensors) and an electronic network (e.g., network 446) in order to communicate a variety of data related to maintenance, analytics, performance, etc. The variety of sensors may additionally or alternatively communicate directly with a controller (e.g., BMS controller 366) and/or BMS 400.

Motor 504 can be powered by a variable speed drive (VSD) 510. In some embodiments, VSD 510 receives alternating current (AC) power having a fixed line voltage and fixed line frequency from an AC power source (not shown) and provides power having a variable voltage and frequency to motor 504. Motor 504 can be any type of electric motor that can be powered by VSD 510. For example, motor 504 can be a high speed induction motor. Compressor 502 can be driven by motor 504 to compress a refrigerant vapor received from evaporator 508 through a suction line 512. Compressor 502 may then delivers compressed refrigerant vapor to condenser 506 through a discharge line. Compressor 502 can be a centrifugal compressor, a screw compressor, a scroll compressor, a turbine compressor, or any other type of suitable compressor.

Evaporator 508 can include an internal tube bundle (not shown), a supply line 520, and a return line 522 for supplying and removing a process fluid to the internal tube bundle. Supply line 520 and return line 522 can be in fluid communication with a component within an HVAC system (e.g., air handler 106) via conduits that circulate the process fluid. In some embodiments, the process fluid is a chilled liquid for cooling a building and can be, but is not limited to, water, ethylene glycol, calcium chloride brine, sodium chloride brine, or any other suitable liquid. Evaporator 508 can be configured to lower the temperature of the process fluid as the process fluid passes through the tube bundle of evaporator 508 and exchanges heat with the refrigerant. Refrigerant vapor is formed in evaporator 508 by the refrigerant liquid delivered to the evaporator 508 exchanging heat with the process fluid and undergoing a phase change to refrigerant vapor.

Refrigerant vapor delivered by compressor 502 to condenser 506 transfers heat to a fluid. Refrigerant vapor condenses to refrigerant liquid in condenser 506 as a result of heat transfer with the fluid. The refrigerant liquid from condenser 506 can flow through an expansion device and be returned to evaporator 508 to complete the refrigerant cycle of the chiller assembly 500. Condenser 506 includes a supply line 516 and a return line 518 for circulating fluid between the condenser 506 and an external component of the HVAC system (e.g., a cooling tower). Fluid supplied to condenser 506 via return line 518 can exchange heat with the refrigerant in condenser 506 and can be removed from the condenser 506 via supply line 516 to complete the cycle. The fluid circulating through the condenser 506 can be water or any other suitable liquid.

### Condition Based Maintenance

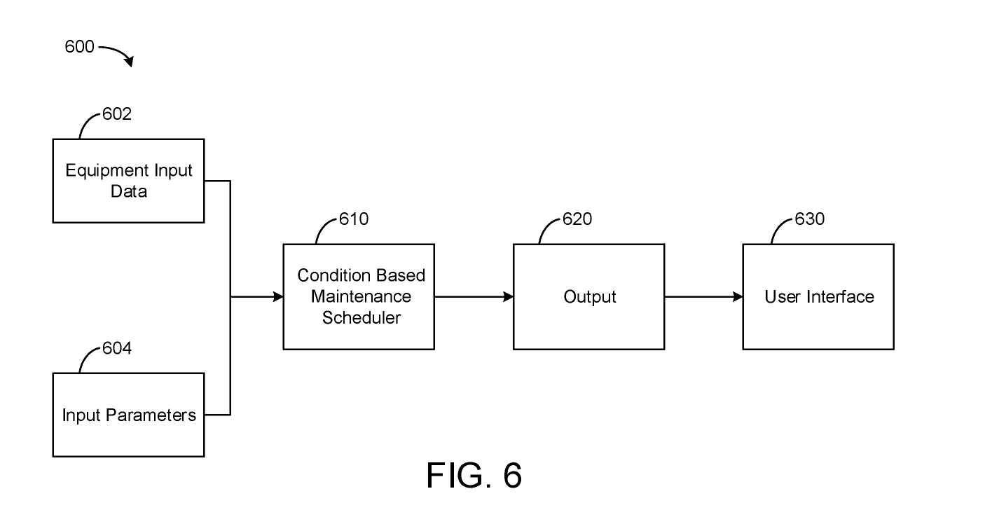

Referring now to FIG. 6, a high level block diagram of a condition based maintenance system 600 is shown, according to some embodiments. System 600 is shown to include input data 602, input parameters 604, a condition based maintenance scheduler 610, an output 620, and a user interface 630. Some or all of the components shown as part of system 600 can be integrated with BMS 400. In some embodiments, BMS 400 includes a connected services dashboard through which data associated with system 600 can be accessed. Building control systems (e.g., HVAC system 100) often lack the ability to prevent equipment failures, safety shutdowns, and other problems with building equipment before they occur. These equipment problems can result in increased cost, increased maintenance, decreased efficiency, and overall undesirable system performance. For example, if building 10 is located in the state of Arizona and chiller 102 incurs a safety shutdown on a hot summer day, people inside the building may experience discomfort due to a lack of air conditioning. In addition, specialized personnel (e.g., maintenance, technicians) may need to perform maintenance work on chiller 102. Condition based maintenance system 600 can be configured to diagnose problems with building equipment before shutdowns or other undesirable outcomes occur. System 600 drives improved performance and efficiency of BMS 400.

Equipment input data 602 can be obtained from any equipment or devices controlled by BMS 400. For example, BMS 400 can read data from temperature sensors, pressure sensors, flow sensors, and other types of sensors associated with building equipment. In addition, data can be collected by trained personnel (e.g., technicians) and uploaded to BMS 400. To name a few examples, input data 602 can be obtained from chillers, boilers, AHUs, and various components thereof. In some embodiments, input data 602 includes optimized time series data as described in U.S. patent application Ser. No. 15/934,593, filed Mar. 23, 2018, the entirety of which is incorporated by reference herein.

Input parameters 604 can include logic (e.g., rules, thresholds, switches) and/or training data that can be used by condition based maintenance scheduler 610 to generate output 620. For example, input parameters 604 can define some or all of the conditions used by condition based maintenance scheduler 610 to flag potential issues with building equipment. Input parameters 604 may be customized based on the location of the building, the types of equipment installed within the building, and other user preferences. For example, a user (e.g., customer) with a building in the state of Arizona may be less concerned about the operation of a boiler than a user with a building in the state of Wisconsin due to climate differences. In this example, the user in Arizona may be more interested in conditions associated with the operation of a chiller and the user in Wisconsin may be more interested in conditions associated with the operation of a boiler. This flexibility allows system 600 to deliver uniquely tailored solutions that meet the needs of a variety of different users. Input parameters 604 may be provided via a .xls file, a .xlsx file, a .csv file, may be entered via an interface of BMS 400, or any combination thereof.

Condition based maintenance scheduler 610 can be configured to flag potential issues with building equipment. For example, condition based maintenance scheduler 610 can be configured to analyze input data 602 according to input parameters 604 and flag potential issues before problems occur. Condition based maintenance scheduler 610 can include a set of rules (e.g., if-then, if-else, else-if statements), one or more machine learning models, one or more deep learning models, or any combination thereof. For example, condition based maintenance scheduler 610 can use predictive modeling systems and methods as described in U.S. patent application Ser. No. 15/331,755, filed Oct. 21, 2016, the entirety of which is incorporated by reference herein. The machine learning models and deep learning models can be trained with historical data (e.g., input data 602 stored over time in an electronic database) in order to dynamically adjust one or more conditions to be flagged by scheduler 610.

Output 620 of condition based maintenance scheduler 610 can include a variety of different information. For example, output 620 can include IDs of equipment analyzed by scheduler 610, timestamps of when the analysis occurs or when the input data was received, any potential issues with building equipment flagged by scheduler 610, information about operating conditions (e.g., type of refrigerant, weather, energy usage), or any combination thereof.

A variety of data associated with system 600 can be presented via a user interface 630. In some embodiments, the user interface is a connected services dashboard interface associated with BMS 400. Interface 630 can be accessed from a personal computer, a mobile phone, a tablet, a workstation, and other types of devices. Information about input data 602, input parameters 604, scheduler 610, and output 620 can be viewed via interface 630. In addition, if scheduler 610 detects any problems, one or more alerts may be generated and presented via interface 630. For example, if scheduler 610 detects that a chiller shutdown is likely to occur, system 600 can send an alert to a technician responsible for performing maintenance on the chiller. In some embodiments, one or more maintenance events are scheduled when scheduler 610 detects problematic conditions.

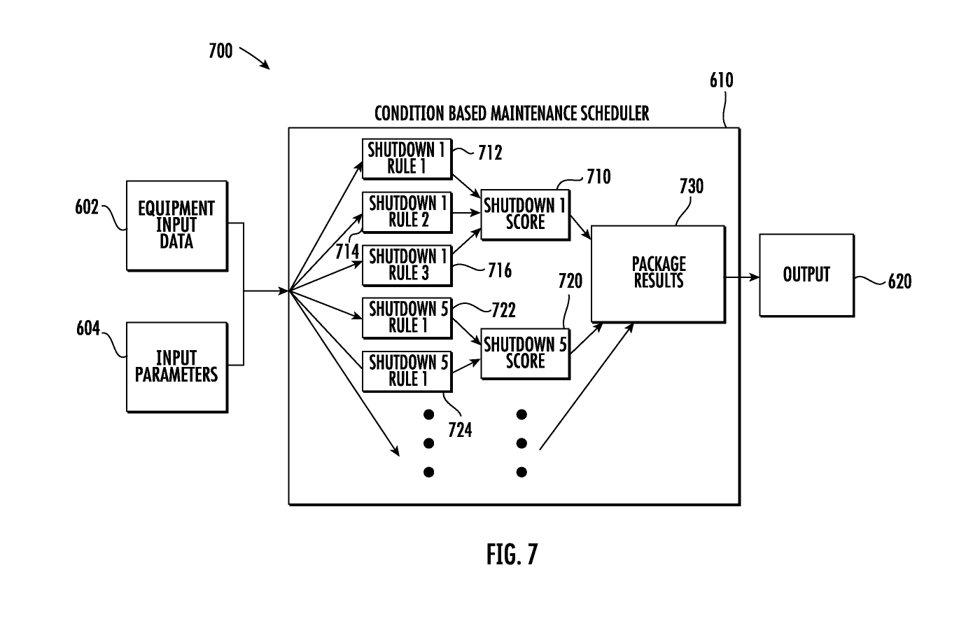

Referring now to FIG. 7, a more detailed block diagram 700 of condition based maintenance scheduler 610 is shown, according to some embodiments. Scheduler 610 is shown to include a number of rules used to determine a number of shutdown scores. For example, rule 712, rule 714, and rule 716 can be used to determine a shutdown score 710. In some embodiments, input parameters 604 define some or all of the rules and shutdown scores. Shutdown score 710 may represent a potential problem associated with building equipment and rules 712, 714, 716 may represent potentially problematic conditions associated with the building equipment. Scheduler 610 can be configured to compare input data 602 to these problematic conditions in order to determine potential problems. For example, shutdown score 710 may indicate a likelihood of a safety shutdown of chiller assembly 500 occurring due to low pressure within evaporator 508. In this example, scheduler 610 may determine the shutdown is likely to occur if a drop leg temperature falls below a threshold (e.g., rule 712), a pressure within evaporator 508 falls below a threshold (e.g., rule 714), and/or an approach temperature of evaporator 508 rises above a threshold (e.g., rule 716).

The configuration of rules and shutdown scores shown in diagram 700 are meant to be exemplary, as any number of rules, shutdown scores, and relationships thereof are contemplated within the scope of this disclosure. As mentioned above, system 600 has the ability to adapt to a variety of different applications (e.g., some of which is provided via the ability to customize input parameters 604). Diagram 700, for example, is shown to include a second shutdown score 720 dependent on two rules 722 and 724. Shutdown score 720, for example, may indicate a likelihood of a safety shutdown of chiller assembly 500 occurring due to high pressure within condenser 506. In this example, scheduler 610 may determine the shutdown is likely to occur if an approach temperature of condenser 506 rises above a threshold (e.g., rule 722) and/or a pressure within condenser 506 rises above a threshold (e.g., rule 724). Condition based maintenance scheduler 610 may then package results (block 730) together in order to provide an indication of any potential problems with building equipment discovered by comparing input data 602 to the set of conditions defined, at least in part, by input parameters 604.

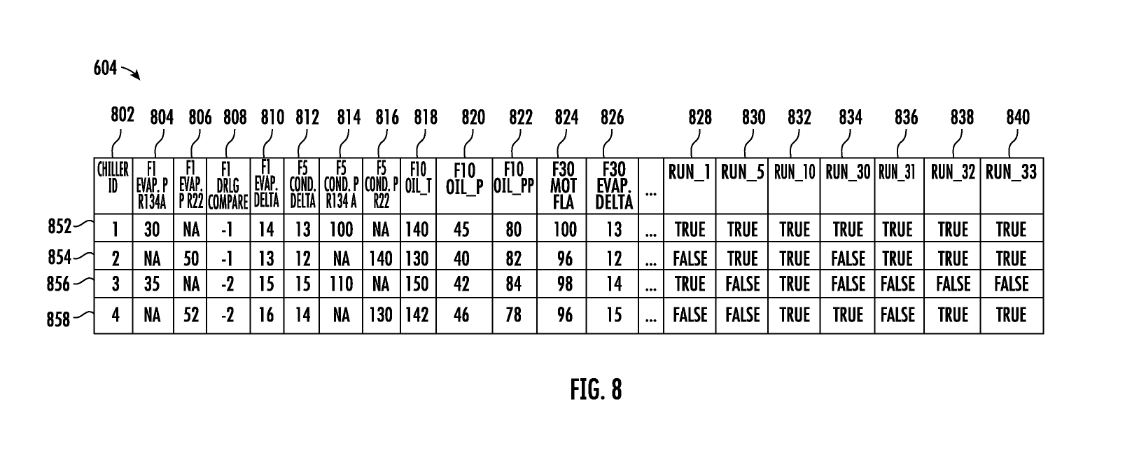

Referring now to FIG. 8, a table depicting an example of input parameters 604 is shown, according to some embodiments. The table is shown to include an equipment ID column 802 that identifies four chillers 852, 854, 856, and 858. Column 802 may also identify other types building equipment (e.g., boiler, air handling unit, etc.), however the example table shown in FIG. 8 is specific to chillers. The four chillers may each be located within the same building or building campus, for example. A number of rules (e.g., set of conditions used to flag potential problems) are shown to be associated with each of the four chillers.

For example, columns 804 and 806 identify evaporator pressure as a condition of interest. Column 804 in particular identifies a threshold pressure level of 30 psi for chiller 852 running R134A type refrigerant. If a pressure reading of input data 602 falls below 30 psi, then condition based maintenance scheduler 610 can determine that a safety fault is likely to occur due to low evaporator pressure. Column 804 also shows that, for chiller 854, this threshold is not applicable because chiller 854 may not be configured to circulate R134A type refrigerant, for example.

Still referring to FIG. 8, the example table of input parameters 604 is shown to include a number of additional conditions of interest associated with the four chillers. For example, column 808 identifies drop leg temperature as a condition of interest. The drop leg compare temperature shown in column 808 can be defined as a difference between drop leg temperature and condenser water supply temperature (e.g., DRLG COMPARE=drop leg temp [° F.]−condenser water supply temperature [° F.]). Columns 810 and 826 identify a change in temperature associated with an evaporator as a condition of interest. Column 812 identifies a change in temperature associated with a condenser as a condition of interest. Columns 814 and 816 identify condenser pressure as a condition of interest. Columns 818, 820, and 822 identify oil sump temperature, oil sump pressure, and oil pump pressure, respectively, as conditions of interest. Column 824 identifies full-load-amperage of an electric motor as a condition of interest. A threshold value or other value of interest for each of these conditions and for each of the four chillers is shown in the table.

Still referring to FIG. 8, columns 828, 830, 832, 834, 836, 838, and 840 represent conditions that can be toggled on or off. For example, a user may include many conditions of interest in input parameters 604 but may not be interested in all of the conditions at all times. Columns 828, 830, 832, 834, 836, 838, and 840 may be used to toggle any conditions, rules, shutdown scores, maintenance events, etc. In some embodiments, users will use a predefined or factory version of input parameters 604 and may choose to simply toggle off any of these predefined parameters. This functionality provides greater flexibility for users of BMS 400.

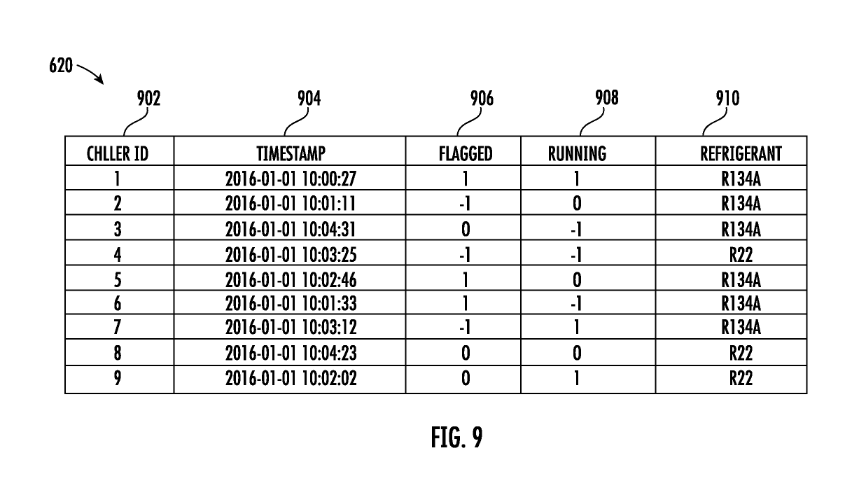

Referring now to FIG. 9, a table depicting an example of output 620 is shown, according to some embodiments. As shown, the table may include a column 602 that identifies a particular piece of building equipment (e.g., chiller located in room 2200). The building equipment can includes chillers, boilers, air handling units, or any other type of building equipment. In addition, the table is shown to include a column 904 that includes a timestamp. The timestamp may specify a time at which input data 602 was received, a time at which output 620 was produced by condition based scheduler 610, any other timestamp or interest, or any combination thereof. In some embodiments, input data 602 is sampled at a defined time interval (e.g., 15 minutes) and a new output 620 is generated during each time interval. Also shown in the table is a column 910 that can indicate a type of refrigerant (e.g., R134A, R22) being used within chiller assembly 500. Column 910 may additionally or alternatively indicate other additional variables associated with building equipment.

Still referring to FIG. 9, the table is also shown to include a column 906 that provides an indication of whether any potential problems have been flagged. For example, column 906 may include a “1” if one or more potential problems (e.g., possible shutdown due to low pressure of evaporator 508) have been flagged by scheduler 610. Column 906 may include a “0” if no potential problems have been flagged. In addition, column 906 may include a “−1” if incomplete information (e.g., missing parts of input data 602) was provided to scheduler 610 or if another type of error occurred. Column 908 may provide an indication of whether the building equipment was running (e.g., “1), not running (e.g., “0”), or some type of error or missing information presented scheduler 610 from determining the running status of the building equipment (e.g., “−1”). Output 620 and input data 602 can be presented to users of BMS 400 via a dashboard interface. This dashboard interface may be a web interface that can be accessed from a variety of devices such as a smartphone, personal computer, laptop, workstation, or tablet.

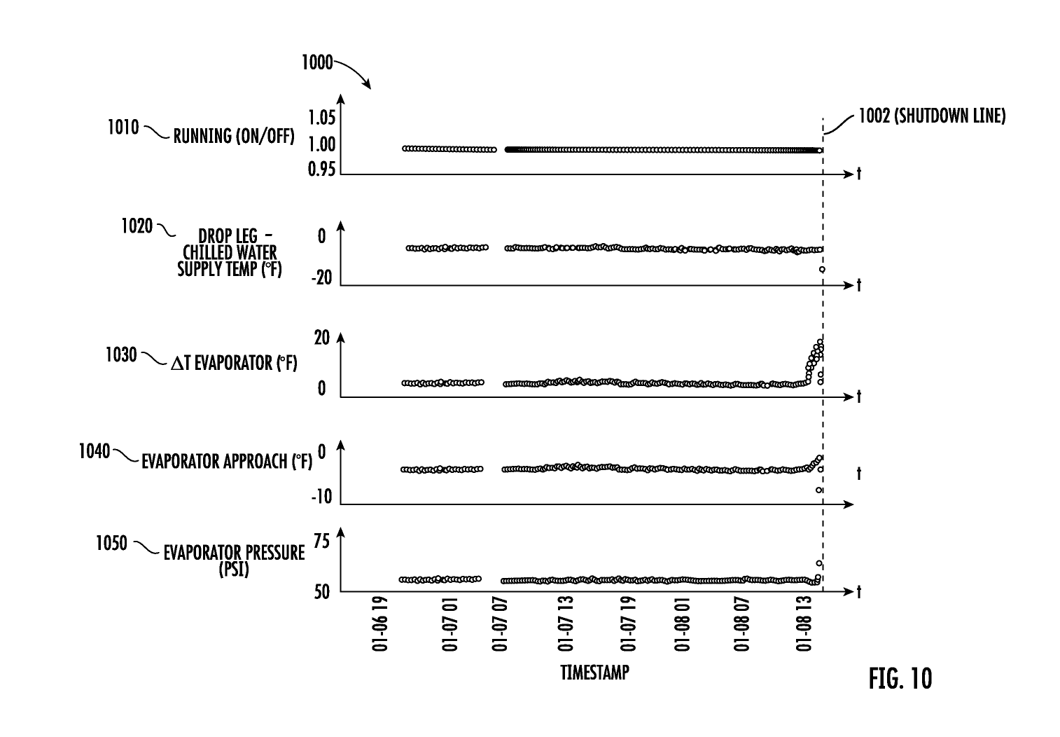

Referring now to FIGS. 10-14, examples of input data 602 that can be received from chiller assembly 500 are shown, according to various embodiments. The data shown in FIGS. 10-14 can be used to determine various input parameters 604. For example, each of the graphs in FIGS. 10-14 are aligned along a time axis and include a “shutdown line” representing a point in time where chiller assembly 500 incurs a shutdown (e.g., safety shutdown). The data in the graphs shown in FIGS. 10-14 provides insight into why shutdowns of chiller assembly 500 may occur. These shutdowns can be catastrophic in nature and can cause major problems with HVAC equipment. This insight can be used to determine conditions (e.g., input parameters 604) that will be flagged by condition based maintenance scheduler 610. These conditions may then be used to determine a number of potential problems (e.g., faults) associated with building equipment. As a result, BMS 400 can schedule maintenance on chiller assembly 500 before a shutdown, failure, or other type of problem occurs.

Referring specifically to FIG. 10, a graph 1000 of input data 602 that can be received from chiller assembly 500 is shown, according to some embodiments. Graph 1000 includes five sub-graphs of different variables associated with chiller assembly 500. The variables depicted in these sub-graphs can be used to determine conditions that may lead to a shutdown due to low pressure within evaporator 508. Graph 1010 provides an indication of whether chiller assembly 500 is running or is not running, for example. Shutdown line 1002 depicts the point in time where chiller assembly 500 experiences a shutdown.

Graph 1020 illustrates a measurement of drop leg temperature compared to chilled water supply temperature. Measurements of drop leg temperature shown in graph 1020 can be obtained from a sensor located in or near a drop leg portion of chiller assembly 500 that is connected to shells of condenser 506 and evaporator 508, for example. Measurements of chilled water supply temperature can be obtained from a sensor located in or near supply line 516, for example. The drop leg compare temperature shown in graph 1020 can be defined as a difference between drop leg temperature and condenser water supply temperature (e.g., drop leg−chilled water supply temp (° F.)=drop leg temperature−condenser water supply temperature). Flash gas may be present in chiller assembly 500 if the difference between these two temperatures is less than zero. Flash gas is refrigerant that remains in a gaseous state when it should be in a liquid state. The presence of flash gas can significantly reduce chiller efficiency and cause various problems with chiller assembly 500. In some embodiments, graph 1020 corresponds (at least in part) to column 808. As shown, a sharp decrease in drop leg compare temperature can be seen shortly before shutdown occurs.

Graph 1030 illustrates a temperature change associated with evaporator 508. Temperature measurements shown in graph 1030 can be obtained from one or more temperature sensors located within evaporator 508, for example. In some embodiments, graph 1030 represents a difference between two temperature sensor readings (e.g., ΔT=evaporator return water temperature−evaporator supply water temperature). This ΔT is sometimes referred to as the evaporator range. In some embodiments, graph 1030 corresponds (at least in part) to columns 810 and 826. As shown, a sharp increase in the evaporator ΔT can be seen shortly before shutdown occurs.

Graph 1040 illustrates approach temperature of evaporator 508. In some embodiments, the approach temperature is defined as the difference between liquid water leaving evaporator 508 and refrigerant temperature within evaporator 508. Approach temperature provides an indication of efficiency of evaporator 508. In some embodiments, chiller assembly 500 includes a design approach temperature (e.g., factory setting). An increase in approach temperature may indicate a decrease in efficiency of evaporator 508. For example, an increasing evaporator approach temperature signifies that chiller assembly 500 may be consuming more energy and/or delivering less cooling capacity. As shown, an increase in evaporator approach temperature can be seen shortly before shutdown occurs.

Graph 1050 illustrates pressure within evaporator 508. Measurements shown in graph 1050 can be obtained from one or more pressure sensors within evaporator 508, for example. In some embodiments, graph 1050 corresponds (at least in part) to columns 804 and 806. As shown, an increase in evaporator pressure can be seen shortly before shutdown occurs.

Graph 1000 provides insight into why shutdowns or other problems associated with chiller assembly 500 may occur due to low pressure within evaporator 508. From graph 1020, it can be determined that a drop leg compare temperature that falls below a threshold level of about zero degrees Fahrenheit is a potential problem. From graph 1030, it can be determined that an evaporator temperature change rising above a threshold of about 12 to 17 degrees (depending on the application) is a potential problem. From graph 1040, it can be determined that an evaporator approach temperature that approximately doubles (e.g., twice the design approach temperature) is a potential problem. From graph 1050, it can be determined that an evaporator pressure falling below a threshold level of about 30 pounds per square inch (psi) for R134A type refrigerant or about 50 psi for R22 type refrigerant is a potential problem.

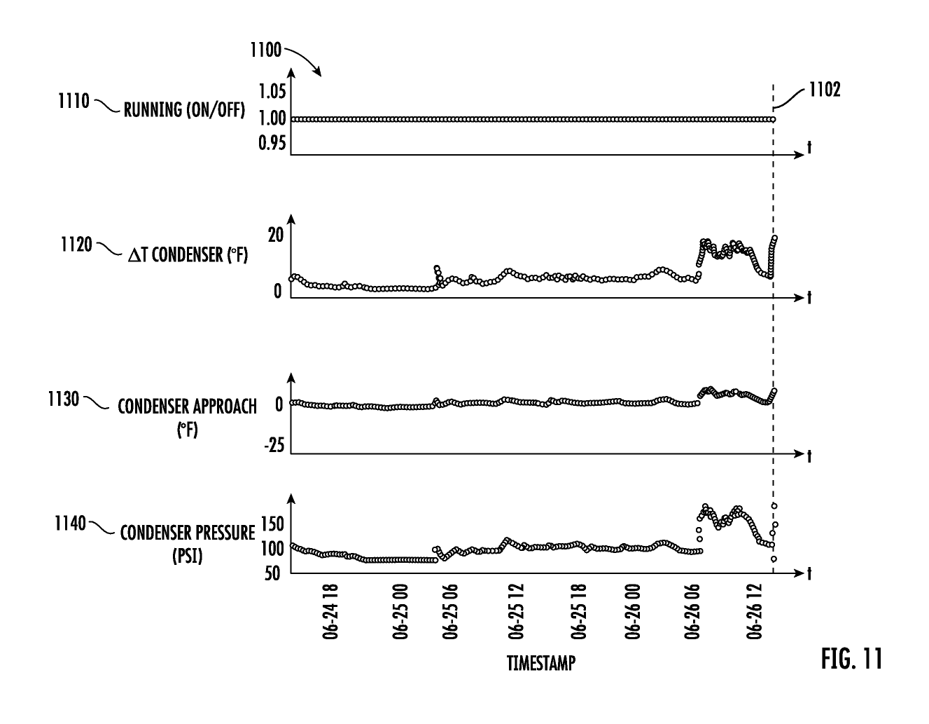

Referring now to FIG. 11, a graph 1100 of input data 602 that can be received from chiller assembly 500 is shown, according to some embodiments. Graph 1100 includes four sub-graphs of different variables associated with chiller assembly 500. The variables depicted in these sub-graphs can be used to determine conditions that may lead to a shutdown due to high pressure within condenser 506. Graph 1110 provides an indication of whether chiller assembly 500 is running and shutdown line 1102 depicts the point in time where chiller assembly 500 experiences a shutdown.

Graph 1120 illustrates a temperature change associated with condenser 506. Temperature measurements shown in graph 1120 can be obtained from one or more temperature sensors located within condenser 506, for example. In some embodiments, graph 1120 represents a difference between two temperature sensor readings (e.g., ΔT=condenser return water temperature−condenser supply water temperature). This ΔT is sometimes referred to as the condenser range. In some embodiments, graph 1120 corresponds (at least in part) to column 812. As shown in graph 1120, the ΔT of condenser 506 experiences a sharp increase and becomes more volatile about six hours before shutdown occurs.

Graph 1130 illustrates approach temperature of condenser 506. In some embodiments, the approach temperature is defined as the difference between liquid water leaving condenser 506 and refrigerant temperature within condenser 506. Approach temperature provides an indication of efficiency of evaporator 508. In some embodiments, chiller assembly 500 includes a design approach temperature (e.g., factory setting). An increase in approach temperature may indicate a decrease in efficiency of condenser 506. For example, an increasing condenser approach temperature signifies that chiller assembly 500 may be consuming more energy and/or delivering less cooling capacity. As shown, an increase in condenser approach temperature can be seen shortly before shutdown occurs.

Graph 1140 illustrates pressure within condenser 506. Measurements shown in graph 1140 can be obtained from one or more pressure sensors installed within condenser 506, for example. In some embodiments, graph 1140 corresponds (at least in part) to columns 814 and 816. As shown, an increase in condenser pressure can be seen shortly before shutdown occurs.

Graph 1100 provides insight into why shutdowns or other problems associated with chiller assembly 500 may occur due to high condenser pressure. From graph 1120, it can be determined that a condenser temperature change rising above a threshold level of about 12 to 17 degrees (depending on the application) is a potential problem. From graph 1130, it can be determined that a condenser approach temperature that approximately doubles (e.g., twice the design approach temperature) is a potential problem. From graph 1140, it can be determined that a condenser pressure rising above a threshold level of about 100 psi for R134A type refrigerant or about 140 psi for R22 type refrigerant is a potential problem.

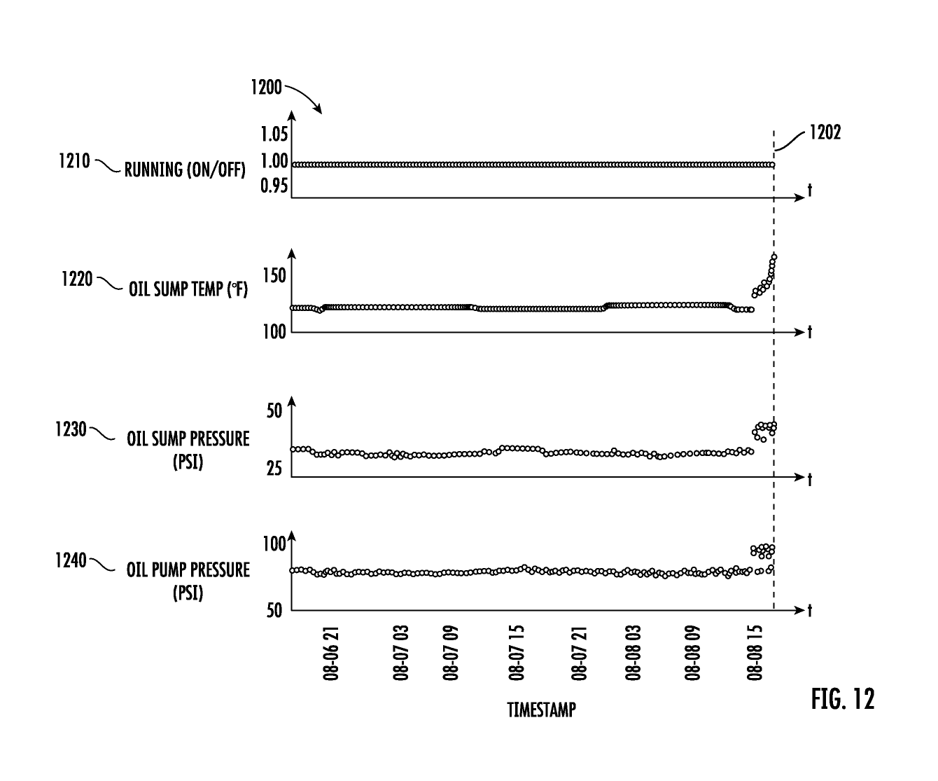

Referring now to FIG. 12, a graph 1200 of input data 602 that can be received from chiller assembly 500 is shown, according to some embodiments. Graph 1200 includes four sub-graphs of different variables associated with chiller assembly 500. The variables depicted in these sub-graphs can be used to determine conditions that may lead to a shutdown due to high oil pressure. Oil or another type of lubricant can be used in components of chiller assembly 500 such as motor 504 and compressor 502, for example. Graph 1210 provides an indication of whether chiller assembly 500 is running and shutdown line 1202 depicts the point in time where chiller assembly 500 experiences a shutdown.

Graph 1220 illustrates the temperature of oil residing in a sump associated with chiller assembly 500. The sump is designed to hold oil that has not yet been circulated through chiller assembly 500. The sump can be located near compressor 502 or motor 504, for example. Measurements shown in graph 1220 can be obtained from one or more temperature sensors located within or near the oil sump. In some embodiments, graph 1220 corresponds (at least in part) to column 818. As shown, a sharp increase in oil sump temperature can be seen shortly before the shutdown occurs.

Graph 1230 illustrates the pressure of oil residing in the sump located near compressor 502. As mentioned above, however, an oil sump may be additionally or alternatively located near other components of chiller assembly 500 such as motor 504. Measurements shown in graph 1230 can be obtained from one or more pressure sensors located near the oil sump, for example. In some embodiments, graph 1230 corresponds (at least in part) to column 820. As shown, a sharp increase in oil sump pressure can be seen shortly before shutdown occurs.

Graph 1240 illustrates oil pump pressure. An oil pump may be used near compressor 502, for example, to remove excess oil residing in the oil sump. Measurements shown in graph 1240 may be obtained from one or more pressure sensors located near the oil pump, for example. In some embodiments, graph 1240 corresponds (at least in part) to column 822. As shown, a sharp increase in oil pump pressure can be seen shortly before shutdown occurs.

Graph 1200 provides insight into why shutdowns or other problems associated with chiller assembly 500 may occur due to high oil temperature. From graph 1220, it can be determined that an oil sump temperature rising above a threshold level of about 120 to 160 degrees Fahrenheit is a potential problem. From graph 1230, it can be determined that an oil sump pressure rising above a threshold level of about 40 to 50 psi is a potential problem. From graph 1240, it can be determined that an oil pump pressure rising above a threshold level of about 75 to 85 psi is a potential problem.

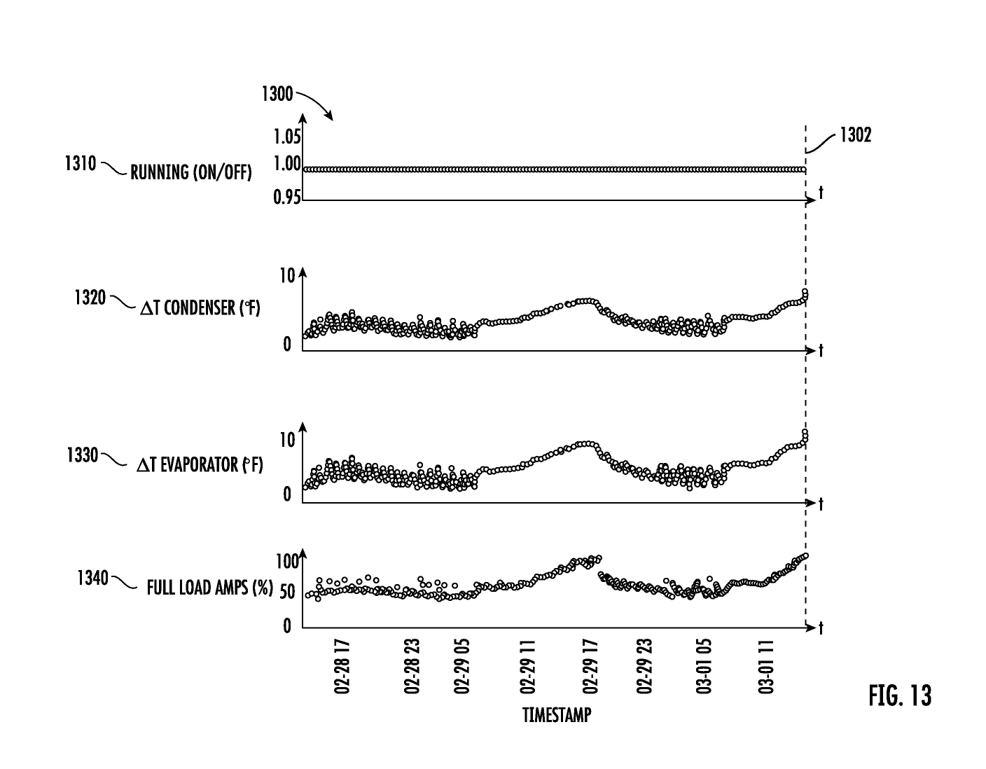

Referring now to FIG. 13, a graph 1300 of input data 602 that can be received from chiller assembly 500 is shown, according to some embodiments. Graph 1300 includes four sub-graphs of different variables associated with chiller assembly 500. The variables depicted in these sub-graphs can be used to determine conditions that may lead to a shutdown due to current overload of motor 504. Graph 1310 provides an indication of whether chiller assembly 500 is running and shutdown line 1302 depicts the point in time where chiller assembly 500 experiences a shutdown.

Graph 1320 illustrates a temperature change associated with condenser 506. Temperature measurements shown in graph 1320 can be obtained from one or more temperature sensors located within condenser 506, for example. In some embodiments, graph 1320 represents a difference between two temperature sensor readings (e.g., ΔT=condenser return water temperature−condenser supply water temperature). This ΔT is sometimes referred to as the condenser range. In some embodiments, graph 1320 corresponds (at least in part) to column 812. As shown in graph 1320, the ΔT of condenser 506 experiences a sharp increase and becomes more volatile about six hours before shutdown occurs.

Graph 1330 illustrates a change in temperature associated with evaporator 508. Temperature measurements shown in graph 1330 can be obtained from one or more temperature sensors located within evaporator 508, for example. In some embodiments, graph 1330 represents a difference between two temperature sensor readings (e.g., ΔT=evaporator return water temperature−evaporator supply water temperature). This ΔT is sometimes referred to as the evaporator range. In some embodiments, graph 1330 corresponds (at least in part) to columns 810 and 826. As shown, a sharp increase in the evaporator ΔT can be seen shortly before shutdown occurs.

Graph 1340 illustrates full-load-amperage of VSD 510. Measurements shown in graph 1340 can be obtained from one or more sensors associated with VSD 510, for example. If VSD 510 outputs a higher current than it is rated for, a safety shutdown of chiller assembly 500 can occur. In some embodiments, graph 1340 corresponds (at least in part) to column 824. As shown, the full-load-amperage of VSD 510 crosses above 100% shortly before shutdown occurs.

Graph 1300 provides insight into why shutdowns or other problems associated with chiller assembly 500 may occur due to current overload of motor 504. From graph 1320, it can be determined that it can be determined that an evaporator temperature change rising above a threshold of about 12 to 17 degrees (depending on the application) is a potential problem. From graph 1330, it can be determined that a condenser temperature change rising above a threshold of about 12 to 17 degrees (depending on the application) is a potential problem. From graph 1340, it can be determined that a full-load-amperage of motor 504 rising above a threshold level of about 100% is a potential problem.

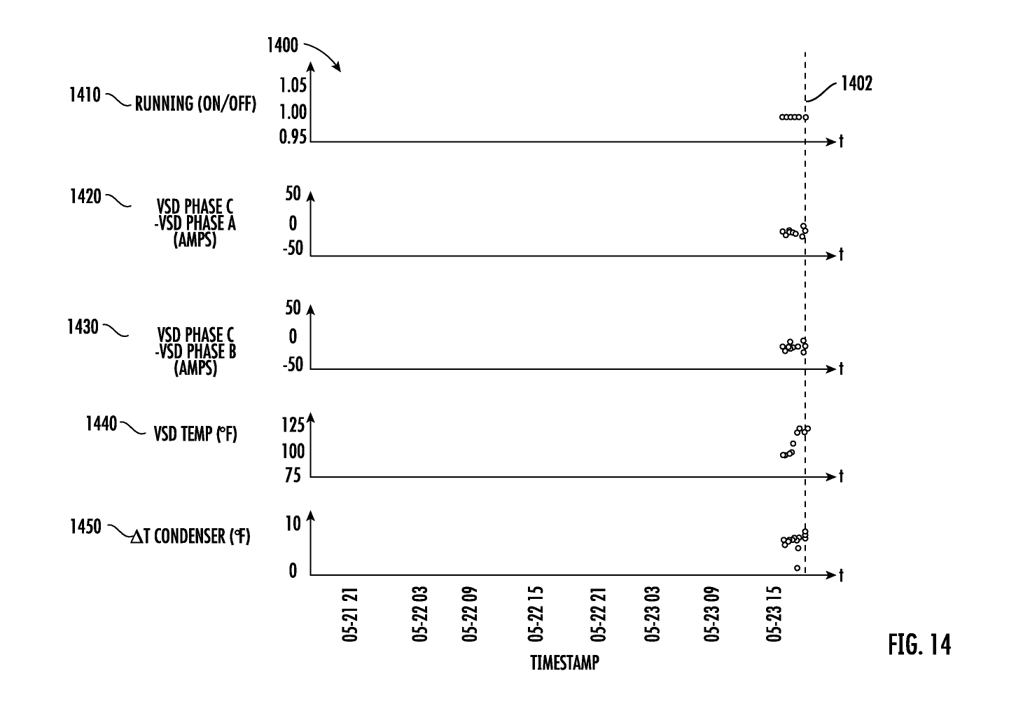

Referring now to FIG. 14, a graph 1400 of input data 602 that can be received from chiller assembly 500 is shown, according to some embodiments. Graph 1400 includes four sub-graphs of different variables associated with chiller assembly 500. The variables depicted in these sub-graphs can be used to determine conditions that may lead to a shutdown due to high heat sink temperature of VSD 510. For example, VSD 510 may include a phase A inverter, a phase B inverter, and a phase C inverter, each having its own heat sink. If any one of these heat sinks gets too hot, chiller assembly 500 may experience a shutdown. Graph 1410 provides an indication of whether chiller assembly 500 is running and shutdown line 1402 depicts the point in time where chiller assembly 500 experiences a shutdown.

Graph 1440 illustrates ambient air temperature within VSD 510. Measurements shown in graph 1440 can be obtained from one or more temperature sensors associated with VSD 510, for example. As shown, a sharp increase in VSD ambient air temperature can be seen shortly before shutdown occurs.

Graph 1420 illustrates a difference in amperage between the phase C inverter and the phase A inverter of VSD 510. Graph 1430 illustrates a difference in amperage between the phase C inverter and the phase B inverter of VSD 510. During normal operation, the difference in amperage between any two inverters of VSD 510 will be approximately zero. As shown in graph 1420, the difference remains fairly close to zero before shutdown and not much of a change can be seen until right before the shutdown occurs (e.g., about 30 minutes or less). However, these differences in amperage can provide an indication of which inverter is causing a problem if an increase in VSD ambient air temperature occurs. For example, if phase C current is greater than phase A current and phase C current is also greater than phase B current, then it is likely the heat sink of inverter C is problematic. Similarly, if phase B current is greater than phase A current and phase B current is also greater than phase C current, then it is likely the heat sink of inverter B is problematic. Additionally, if phase A current is greater than phase B current and phase A current is also greater than phase C current, then it is likely the heat sink of inverter A is problematic.

Graph 1450 illustrates a change in temperature associated with condenser 506. Temperature measurements shown in graph 1450 can be obtained from one or more temperature sensors located within condenser 506, for example. In some embodiments, graph 1450 represents a difference between two temperature sensor readings (e.g., ΔT=condenser return water temperature−condenser supply water temperature). This ΔT is sometimes referred to as the condenser range. In some embodiments, graph 1450 corresponds (at least in part) to column 812. As shown in graph 1450, the ΔT of condenser 506 experiences an increase and becomes more volatile shortly before shutdown occurs.

Graph 1400 provides insight into why shutdowns or other problems associated with chiller assembly 500 may occur due to high heat sink temperature of VSD 510. Graphs 1420 and 1430 provide an example of how a particular inverter of VSD 510 can be deemed problematic. From graph 1440, it can be determined that a VSD ambient air temperature rising above a threshold level of about 110 to 130 degrees Fahrenheit is a potential problem. From graph 1450, it can be determined that a condenser temperature change rising above a threshold level of about 12 to 17 degrees (depending on the application) is a potential problem.

### Configuration of Exemplary Embodiments

The construction and arrangement of the systems and methods as shown in the various exemplary embodiments are illustrative only. Although only a few embodiments have been described in detail in this disclosure, many modifications are possible (e.g., variations in sizes, dimensions, structures, shapes and proportions of the various elements, values of parameters, mounting arrangements, use of materials, colors, orientations, etc.). For example, the position of elements may be reversed or otherwise varied and the nature or number of discrete elements or positions may be altered or varied. Accordingly, all such modifications are intended to be included within the scope of the present disclosure. The order or sequence of any process or method steps may be varied or re-sequenced according to alternative embodiments. Other substitutions, modifications, changes, and omissions may be made in the design, operating conditions and arrangement of the exemplary embodiments without departing from the scope of the present disclosure.

The present disclosure contemplates methods, systems and program products on any machine-readable media for accomplishing various operations. The embodiments of the present disclosure may be implemented using existing computer processors, or by a special purpose computer processor for an appropriate system, incorporated for this or another purpose, or by a hardwired system. Embodiments within the scope of the present disclosure include program products comprising machine-readable media for carrying or having machine-executable instructions or data structures stored thereon. Such machine-readable media can be any available media that can be accessed by a general purpose or special purpose computer or other machine with a processor. By way of example, such machine-readable media can comprise RAM, ROM, EPROM, EEPROM, CD-ROM or other optical disk storage, magnetic disk storage or other magnetic storage devices, or any other medium which can be used to carry or store desired program code in the form of machine-executable instructions or data structures and which can be accessed by a general purpose or special purpose computer or other machine with a processor. When information is transferred or provided over a network or another communications connection (either hardwired, wireless, or a combination of hardwired or wireless) to a machine, the machine properly views the connection as a machine-readable medium. Thus, any such connection is properly termed a machine-readable medium. Combinations of the above are also included within the scope of machine-readable media. Machine-executable instructions include, for example, instructions and data which cause a general purpose computer, special purpose computer, or special purpose processing machines to perform a certain function or group of functions.

Although the figures show a specific order of method steps, the order of the steps may differ from what is depicted. Also two or more steps may be performed concurrently or with partial concurrence. Such variation will depend on the software and hardware systems chosen and on designer choice. All such variations are within the scope of the disclosure. Likewise, software implementations could be accomplished with standard programming techniques with rule based logic and other logic to accomplish the various connection steps, processing steps, comparison steps and decision steps.

What is claimed is:

1. A Building Management System (BMS) configured to monitor and control building equipment comprising:
a plurality of sensors configured to transmit input data associated with the building equipment; and
a condition based maintenance scheduler configured to determine a plurality of potential problems associated with the building equipment by comparing the input data to a set of conditions;
wherein each condition of the set of conditions is evaluated as true or false as a result of comparing the input data to the set of conditions, and wherein each problem of the potential problems depends on a plurality of the conditions being evaluated as true or false;
wherein the condition based scheduler is further configured to schedule a plurality of maintenance events associated with the building equipment based on the plurality of potential problems.

2. The BMS of claim 1, wherein the building equipment includes a chiller assembly configured to remove heat from a liquid by performing a vapor-compression cycle or an absorption refrigeration cycle.

3. The BMS of claim 2, wherein the number of potential problems includes at least one of:
low pressure within an evaporator of the chiller assembly;
high pressure within a condenser of the chiller assembly;
high temperature of oil near a compressor of the chiller assembly;
current overload of an electric motor of the chiller assembly; and
high temperature of one or more heat sinks associated with one or more inverters of a variable speed drive of the chiller assembly.

4. The BMS of claim 3, wherein the condition based maintenance scheduler is configured to determine the potential problem of low pressure within the evaporator of the chiller assembly by comparing the input data to the set of conditions, and wherein the set of conditions includes at least one of a temperature difference threshold between a drop leg temperature and a chilled water supply temperature, an evaporator temperature change threshold, an evaporator approach temperature threshold, and an evaporator pressure threshold.

5. The BMS of claim 4, wherein at least one of the following is true:
the temperature difference threshold is zero degrees Fahrenheit;
the evaporator temperature change threshold is between 12 and 17 degrees Fahrenheit;
the evaporator approach temperature threshold is twice that of a designed evaporator approach temperature; and
the evaporator pressure threshold varies depending on a type of the liquid.

6. The BMS of claim 3, wherein the condition based maintenance scheduler is configured to determine the potential problem of high pressure within the condenser of the chiller assembly by comparing the input data to the set of conditions, and wherein the set of conditions includes a condenser temperature change threshold, a condenser approach temperature threshold, and a condenser pressure threshold.

7. The BMS of claim 6, wherein at least one of the following is true:
the condenser temperature change threshold is between 12 and 17 degrees Fahrenheit;
the condenser approach temperature threshold is twice that of a designed condenser approach temperature; and
the condenser pressure threshold varies depending on a type of the liquid.

8. The BMS of claim 3, wherein the condition based maintenance scheduler is configured to determine the potential problem of high temperature of oil near the compressor of the chiller assembly by comparing the input data to the set of conditions, and wherein the set of conditions includes an oil sump temperature threshold, an oil sump pressure threshold, and an oil pump pressure threshold.

9. The BMS of claim 8, wherein at least one of the following is true:
the oil sump temperature threshold is between 120 and 170 degrees Fahrenheit;
the oil sump pressure threshold is between 40 and 50 pounds per square inch; and
the oil pump pressure threshold is between 75 and 85 pounds per square inch.

10. The BMS of claim 3, wherein the condition based maintenance scheduler is configured to determine the potential problem of current overload of an electric motor of the chiller assembly by comparing the input data to the set of conditions, and wherein the set of conditions includes an evaporator temperature change threshold, a condenser temperature change threshold, and a full-load-amperage threshold associated with the electric motor.

11. The BMS of claim 10, wherein at least one of the following is true:
the evaporator temperature change threshold is between 12 and 17 degrees Fahrenheit;
the condenser temperature change threshold is between 12 and 17 degrees Fahrenheit; and
the full-load-amperage threshold is 100 percent.

12. The BMS of claim 3, wherein the condition based maintenance scheduler is configured to determine the potential problem of high temperature of one or more heat sinks associated with one or more inverters of a variable speed drive of the chiller assembly by comparing the input data to the set of conditions, and wherein the set of conditions includes a condenser temperature change threshold and an ambient air temperature threshold associated with the variable speed drive.

13. The BMS of claim 12, wherein at least one of the following is true:
the condenser temperature change threshold is between 12 and 17 degrees Fahrenheit; and
the ambient air temperature threshold is between 110 and 130 degrees Fahrenheit.

14. The BMS of claim 3, further configured to present the input data and the number of potential problems to one or more users via a dashboard interface.

15. The BMS of claim 2, wherein the liquid is a R22 type refrigerant or a R134A type refrigerant.

16. A method performed by a Building Management System (BMS) configured to monitor and control building equipment comprising:
receiving input data associated with the building equipment from a number of sensors;
determining a number of potential problems associated with the building equipment by comparing the input data to a set of conditions, wherein each condition of the set of conditions is evaluated as true or false as a result of comparing the input data to the set of conditions, and wherein each problem of the potential problems depends on a number of the conditions being evaluated as true or false; and
scheduling a number of maintenance events associated with the building equipment based on the number of potential problems.

17. The method of claim 16, wherein the building equipment includes a chiller assembly configured to remove heat from a liquid by performing a vapor-compression cycle or an absorption refrigeration cycle.

18. The method of claim 17, wherein the number of potential problems includes at least one of:
low pressure within an evaporator of the chiller assembly;
high pressure within a condenser of the chiller assembly;
high temperature of oil near a compressor of the chiller assembly;
current overload of an electric motor of the chiller assembly; and
high temperature of one or more heat sinks associated with one or more inverters of a variable speed drive of the chiller assembly.

19. The method of claim 18, wherein the set of conditions includes at least one of an evaporator temperature change threshold, a temperature difference threshold between a drop leg temperature and a chilled water supply temperature, an evaporator approach temperature threshold, an evaporator pressure threshold, a condenser temperature change threshold, a condenser approach temperature threshold, a condenser pressure threshold, an oil sump temperature threshold, an oil sump pressure threshold, an oil pump pressure threshold, a full-load-amperage threshold associated with an electric motor, and an ambient air temperature threshold.

20. A method comprising:
providing a Building Management System (BMS) configured to monitor and control building equipment, the BMS comprising:
a number of sensors configured to transmit input data associated with the building equipment; and
a condition based maintenance scheduler configured to determine a number of potential problems associated with the building equipment by comparing the input data to a set of conditions;
wherein each condition of the set of conditions is evaluated as true or false as a result of comparing the input data to the set of conditions, and wherein each problem of the potential problems depends on a number of the conditions being evaluated as true or false;
wherein the condition based scheduler is further configured to schedule a number of maintenance events associated with the building equipment based on the number of potential problems.
